(19) United States
(12) Patent Application Publication
(10) Pub. No.: US 2012/0054440 A1
(43) Pub. Date: Mar. 1, 2012

(54) SYSTEMS AND METHODS FOR PROVIDING A HIERARCHY OF CACHE LAYERS OF DIFFERENT TYPES FOR INTEXT ADVERTISING

(76) Inventors: Toby Doig, Herts (GB); Dominic Davis, Norfolk (GB)

(21) Appl. No.: 12/872,640

(22) Filed: Aug. 31, 2010

(51) Int. Cl. G06F 12/08

(52) U.S. Cl. 711/122; 711/E12.022; 711/E12.024

(57) ABSTRACT

The present invention is related to a method for determining duplicate clicks via a multi-layered cache. The method includes establishing, by a cache manager executing on a device, a cache comprising a hierarchy of a plurality of cache layers. The cache manager may establish a first cache layer of the plurality of cache layers as a size bounded cache layer. The cache manager may further establish a second cache layer of the plurality of cache layers as a time bounded cache layer. In some embodiments, the second cache layer may encapsulate the first cache layer. The cache manager may receive a request to determine whether a click or an ad view is stored in the cache. The cache manager may determine whether the click or the ad view is stored in one of the first cache layer or the second cache layer.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

This disclosure generally relates to systems and methods of online advertising. In particular, this disclosure relates to systems and methods for providing a hierarchy of cache layers of different types for in-text advertising.

### BACKGROUND

An enterprise serving web pages to a user may wish to provide the user with an easier and quicker access to information the user is looking for. The services of the enterprise may aim to increase the user's satisfaction by decreasing the amount of time the user spends finding the relevant information. As the user searches the world wide web for the relevant information, the user may often open many new web pages which do not include the relevant content. Old web pages from which the user began searching are sometimes closed or lost during the search process. The enterprise may wish to provide the user with an option to find the relevant information without having to exit the current web page in order to access a next one, which may or may not include the information the user is looking for.

Hypertext is a computer-based text used in a web page to provide information to a user and organize the web page content into interconnected associations. These associations may enable the user to easily access information the user chooses or clicks. An instance of such an association is called a hyperlink or hypertext link. A hyperlink, when selected, leads the viewer to another web page (or file or resource, collectively called the destination page). In order to access the supplemental information provided through hyperlinks, viewers may be required to leave their current web pages, which may interrupt a viewer's web browsing experience. In addition, hyperlinks are traditionally generated by human editors, a process that can be both tedious and subject to human errors. In some cases, by the time a viewer tries to visit a destination page of a hyperlink, the destination page may cease to exist or have evolved to no longer provide the related information. In other cases, a user may have to search for other destination pages to try to obtain the desired information. This may lead the user to perform multiple searches and visit several pages to find the desired information. These are some aspects in which illustrates that conventional systems are not optimally designed or configured to enhance users' online experience.

### BRIEF SUMMARY

The time to process an online activity, such as a click on a hyperlink, may depend on the backend platform services that processes the click. Such processing time may introduce a delay or latency to each activity. For example, a platform service (e.g., an augmentation server of an in-text advertising service) may collect and/or analyze the context of a respective webpage, website, user preference and/or other data to process a click. In view of the latency associated with each activity, conventional systems are not always optimized towards enhancing users' online experience. Even when a platform service for processing and/or tracking online activities may not significantly degrade a user's online experience in this way, it is beneficial to improve the processing efficiency and management effectiveness of these platform services, for example in cache management.

A beneficial aspect of platform services is cache management of data handled by the platform services. A platform service may cache any type or form of data received and/or generated by the platform service. For example and in one embodiment, a platform service for online advertising may store data associated with clicks, ad views, encryption or license keys and/or keyfiles. When processing an online activity (e.g., a click on a hyperlink) or an administrative task (e.g., compiling, generating and/or validating statistics on online activity), a platform service may use a structured cache system to manage associated data. A cache manager may manage a hierarchy or collection of cache partitions or layers (hereafter sometimes generally referred to as “layers”). At least some of the layers may be of different types, having different properties and store data in particular arrangements. The different properties and storage arrangements between the cache layers may allow data to be stored, updated, managed, shared, retrieved or otherwise used more efficiently.

In one aspect, the present solution is related to a method of using a cache comprising a hierarchy of a plurality of cache layers of different types. In some embodiments, the method includes establishing, by a cache manager executing on a device, a cache comprising a hierarchy of a plurality of cache layers. Each of the plurality of cache layers may be of a different type. A first cache layer of the hierarchy may include a first cache type. A second cache layer of the hierarchy may include a second cache type. The cache manager may receive a request for a data item. The cache manager may request the data item from the second cache layer. The cache manager may determine that the data item does not exist in the second cache layer. The cache manager may request the data item from the first cache layer responsive to the determination.

In some embodiments, the cache manage establishes a second cache layer as a second cache type of one of a size bounded cache layer, a time bounded cache layer, a logging cache layer or a synchronized cache layer. The cache manager may establish a first cache layer as a first cache type of a memory cache. The cache manager may receive a data item to cache. The data item may be stored in each of the plurality of cache layers. The cache manager may store the data item to the second cache layer. The cache manager may establish the second cache layer as encapsulating the first cache layer.

In some embodiments, the method includes requesting by one of the cache manager or the second cache layer, the data item from the first cache layer. The cache manager may respond to the request with the data item from the first cache layer. The method may include flushing, by one of the cache manager or the second cache layer, the data item from the second cache layer. The first cache layer may maintain storage of the data item. The cache manager may establish each cache layer of the plurality of cache layers on different networked computing devices.

In another aspect, the present solution is related to a method for determining duplicate clicks via a multi-layered cache. In some embodiments, the method includes establishing, by a cache manager executing on a device, a cache comprising a hierarchy of a plurality of cache layers. The cache manager may establish a first cache layer of the plurality of cache layers as a size bounded cache layer. The cache manager may establish a second cache layer of the plurality of cache layers as a time bounded cache layer. The second cache layer may encapsulate the first cache layer. The cache manager may receive a request to determine whether one of a click or an ad view is stored in the cache. The cache manager may determine whether one of the click or the ad view is stored in one of the first cache layer or the second cache layer.

In some embodiments, the second cache layer may determine that the click or the ad view is not stored in the second cache layer. The second cache layer may communicate a second request to the first cache layer to determine if one of the click or the ad view is stored in the first cache layer. The cache manager may respond to the request with information about one of the click or the ad view as stored in the first cache layer. The cache manager may determine that the click is not stored in the second cache layer and communicate a second request to the first cache layer to determine if the click is stored in the first cache layer. The cache manager may establish a third cache layer of a memory cache encapsulated by the first cache layer encapsulated by the second cache layer.

In some embodiments, the cache manager may establish the first cache layer or the second cache layer as a logging cache layer. The cache manager may establish the first cache layer or the second cache layer as a synchronized cache layer. The second cache layer may flush a cached item from the second cache layer responsive to expiration of a predetermined amount of time. The first cache layer may maintain storage of the cached item. The first cache layer may flush a cached item from the first cache layer responsive to storage for the first cache layer exceeding a predetermined storage size. The second cache layer may maintain storage of the cached item. In certain embodiments, the method may include establishing the first cache layer on a first device and the second cache layer on a second device.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein

FIG. 2 is a block diagram that depicts an embodiment of an augmentation server in FIG. 1.

FIG. 3A is a flow diagram of an embodiment of a method of producing augmented content.

FIG. 3B is a flow diagram of an embodiment of a method of providing augmented content to users.

FIG. 3C is a flow diagram of an embodiment of a process of operation of advertisement and client code.

FIGS. 4A through 4E are screenshots illustrating a web page, its corresponding augmented web page, and a viewer's user experience interacting with the augmented web page according to one embodiment of the present disclosure.

FIG. 5A is block diagram of an embodiment of an ad server platform and platform services.

FIG. 5B is a diagram of an embodiment of stages of a request from a client for platform services.

FIG. 5C is a diagram of an embodiment of contextual targeting.

FIG. 5D is a diagram of another embodiment of contextual targeting.

FIG. 5E is a diagram of an embodiment of contextual and behavioral targeting.

FIG. 5F is a diagram of another embodiment of contextual and behavioral targeting.

FIG. 5G is a diagram of another embodiment of contextual and behavioral targeting.

FIG. 5G is a diagram of an embodiment of campaign selection engine.

FIG. 5I is block diagram of an embodiment of a system to provide augmented content for a keyword on a web page.

FIG. 5J is a diagrammatic view of an embodiment of augmented content.

FIG. 5K is a flow diagram of an embodiment of a method for delivering augmented content for a keyword on a web page.

FIG. 6A is block diagram of an embodiment of a system of using a cache comprising a hierarchy of a plurality of cache layers of different types.

FIG. 6B is a flow diagram of an embodiment of a method of using a cache comprising a hierarchy of a plurality of cache layers of different types.

FIG. 6C is a flow diagram of an embodiment of a method for determining duplicate clicks via a multi-layered cache.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network and computing environment which may be useful for practicing embodiments described herein;
Section B describes embodiments of systems and methods for delivering a augmented content;
Section C describes embodiments of systems and methods of an ad server platform for delivering a plurality of advertisement and augmented content services; and
Section D describes embodiments of systems and methods of using a cache comprising a hierarchy of a plurality of cache layers of different types.

A. System and Network Environment

Some of the disclosed embodiments describe examples of a method (and corresponding system and computer program product) for augmenting files with related resources through layered augmentation. Viewers of the augmented files can access the related resources through a multi-layered dialog box. The process of providing additional resources through multilayered dialog box and the multi-layered dialog box are collectively called layered augmentation.

An embodiment of the method identifies data in a file, associates the identified data with reference data in a reference database, and stores the associations in a corresponding augmented file. A viewer of the augmented file can access resources related to a piece of augmented data through layered augmentation. When the viewer moves a pointer over the piece of augmented data (also called mouse-over), the related resources are provided in a multi-layered dialog box. The dialog box is overlaid on the augmented file approximate to the position where the mouse-over occurred. The viewer can navigate through the related resources in the dialog box without leaving the augmented file.

As described herein, a file includes any types of documents such as web pages. Augmented data, the data with integrated association in an augmented file, include any types of content such as text and image. Resources provided through layered augmentations include textual content, visual content such as images and videos, interactive controls such as dialog boxes, and services such as Internet search service and advertisement. A pointer can be any pointer device such as a mouse, a trackball, a roller, and a touchpad. For purposes of illustration, the method (and corresponding system and computer program product) is described in terms of augmenting keywords (or key phrases) in web pages and delivering related advertisements through multi-layered dialog boxes based on user interactions with the augmented keywords, even though the disclosed embodiments apply to all other types of content, files, and resources as defined above.

The figures and the following description relate to preferred embodiments by way of illustration only. Reference will now be made in detail to several embodiments, examples of which are illustrated in the accompanying figures. The figures depict embodiments of the disclosed system (or method) for purposes of illustration only. It should be noted that from the following discussion, other or alternate embodiments of the structures and methods disclosed herein will be readily recognized by one skilled in the art as viable alternatives that may be employed without departing from the principles described herein.

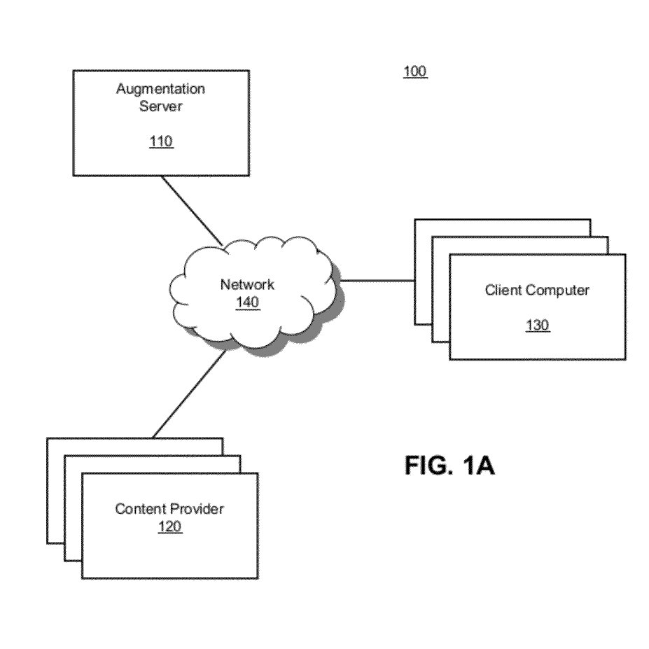

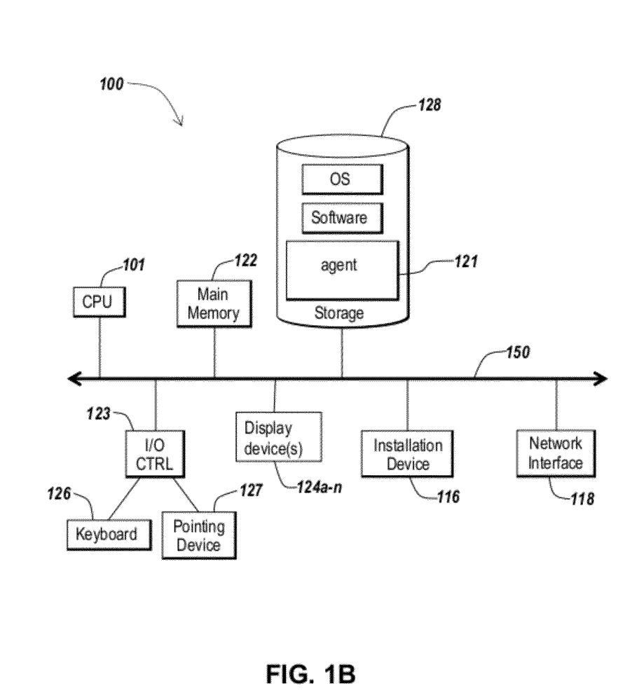

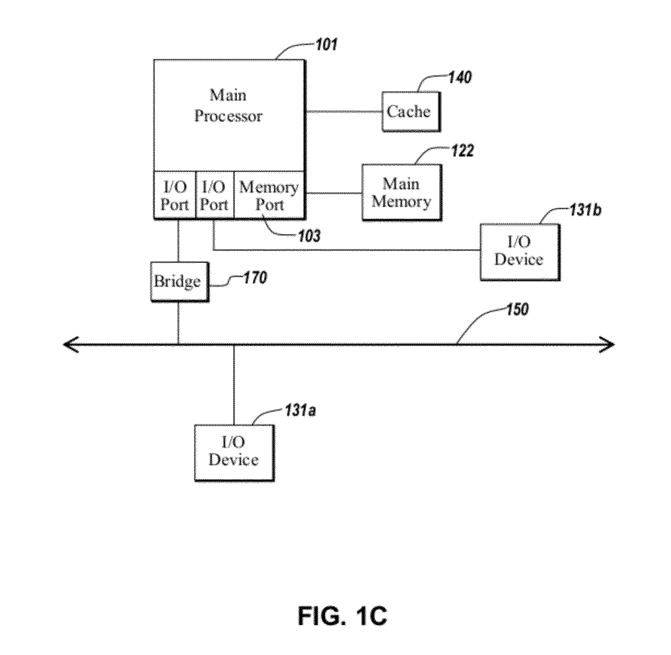

FIG. 1A illustrates an embodiment of a computing environment 100 for augmenting web pages and providing viewers of the augmented web pages with related advertisements through layered augmentation based on user interaction. As illustrated, the computing environment 100 includes an augmentation server 110, multiple content providers (or websites) 120, and one or more client computers (or user systems) 130, all of which are communicatively coupled through a network 140.

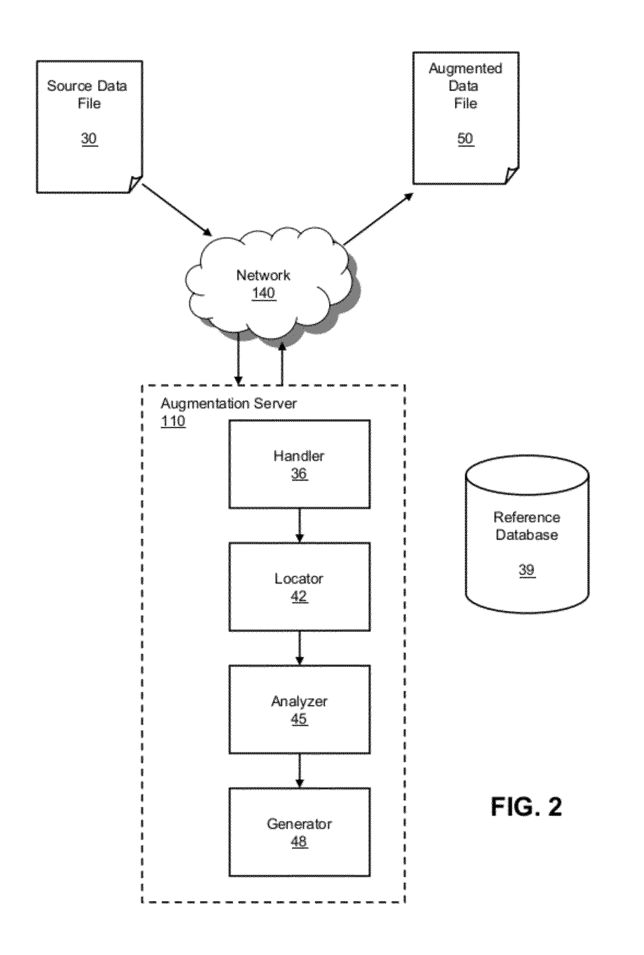

The augmentation server 110 is configured to augment keywords (or other types of content) in web pages (or other types of documents) with advertisements (or other types of resources), and deliver the advertisements based on user interaction with the augmented keywords. The augmentation server 110 retrieves web pages from the content providers 120 and augments the web pages. The augmentation server 110 augments a web page by identifying keywords in the web page, associating (or tagging) the keywords with one or more related references in a reference database, generating an augmented web page, and storing the associations in a database. When a user views an augmented web page in a client computer 130 and moves a pointer over one of the augmented keywords (hereinafter “the activated keyword”), the augmentation server 110 displays (or avails) related advertisements in the client computer 130 through a multi-layered dialog box. An example architecture of the augmentation server 110 is described in detail below with respect to FIG. 2.

The content providers 120 are entities that provide (or generate), host, publish, control, or otherwise have rights over a collection of web pages (or other types of documents). In one embodiment, the content providers 120 are web servers hosting web pages for viewers to access. The content providers 120 may provide web pages to the augmentation server 110 for layered augmentation. Alternatively, the content providers 120 may either instruct or give permission to the augmentation server 110 to retrieve all or parts of their web pages for layered augmentation.

A client 130 may comprise any personal computer (e.g., based on a microprocessor from the x86 family, the Pentium family, the 680x0 family, PowerPC, PA-RISC, MIPS families, the ARM family, the Cell family), network computer, wireless device (e.g. mobile computer, PDA, smartphone), information appliance, workstation, minicomputer, mainframe computer, telecommunications or media device that is capable of communication and that has sufficient processor power and memory capacity to perform the operations described herein. For example, the client 130 may comprise a device of the IPOD family of devices manufactured by Apple Computer of Cupertino, Calif., a PLAYSTATION 2 , PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or NINTENTO WII device manufactured by Nintendo Co., Ltd., of Kyoto, Japan, or an XBOX or XBOX 360 device manufactured by the Microsoft Corporation of Redmond, Wash. In some embodiments, the client may include any of the Kindle family of devices sold or provided by Amazon.com.

Operating systems supported by the client 130 can include any member of the WINDOWS family of operating systems from Microsoft Corporation of Redmond, Wash., MacOS, JavaOS, various varieties of Unix (e.g., Solaris, SunOS, Linux, HP-UX, A/IX, and BSD-based distributions), any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MaC OSX, manufactured by Apple Computer of Cupertino, Calif.; OS/2, manufactured by International Business Machines of Armonk, N.Y.; and Linux, an open source operating system distributed by, among others, Red Hat, Inc., or any type and/or form of a Unix operating system, among others.

The client computers 130 may be any type and form of client devices for users to browse web pages (or other types of documents). In one embodiment, a client computer 130 includes a pointer device (e.g., a mouse, a trackball, a roller, a touchpad, or the like), a conventional web browser (e.g., Microsoft Internet Explorer™, Mozilla Firefox™, or Apple Safari™), and can retrieve and display web pages from the content providers 120 in a conventional manner (e.g., using the HyperText Transfer Protocol). In one embodiment, the client computer 130 displays augmented keywords in an augmented web page differently than the non-augmented content. For example, the augmented keywords can be displayed in a double underline style and/or in a color distinctive from texts that are not augmented. When a user moves a pointer (e.g., mouse pointer) over (e.g., mouse-over) an augmented keyword in the augmented web page, the client computer 130 (or the utilized web browser) generates a request and transmits the request to the augmentation server 110. The augmentation server 110 receives the request and determines relevant advertisements to transmit to the client computer 130. The client computer 130 (or the utilized web browser) displays the advertisements retrieved from the augmentation server 110 in a multi-layered dialog box overlaying the augmented web page and proximate to the location where the mouse-over occurred. The multi-layered dialog box displays an advertisement and multiple clickable tabs representing the other retrieved advertisements. The viewer can select (e.g., click) a tab to request the dialog box to display the corresponding advertisement. The viewer may navigate among the multiple advertisements and interact with the advertisements without leaving the augmented web page.

The network 140 is configured to communicatively connect the augmentation server 110, the content providers 120, and the client computers 130. The network 140 may be a wired or wireless network. Examples of the network 140 include the Internet, an intranet, a WiFi network, a WiMAX network, a mobile telephone network, or a combination thereof. The network 140 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 140 may comprise a wireless link, such as an infrared channel or satellite band. The topology of the network 140 may be a bus, star, or ring network topology. The network 140 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, the augmentation server 110, the content providers 120, and/or the client computers 130 are structured to include a processor, memory, storage, network interfaces, and applicable operating system and other functional software (e.g., network drivers, communication protocols). The client 120, server 110, and content providers 120 may be deployed as and/or executed on any type and form of computing device, such as a computer, network device or appliance capable of communicating on any type and form of network and performing the operations described herein.

FIGS. 1B and 1C depict block diagrams of a computing device 100 useful for practicing an embodiment of the client 130, server 110 or content provider 120. As shown in FIGS. 1B and 1C, each computing device 100 includes a central processing unit 101, and a main memory unit 122. As shown in FIG. 1B, a computing device 100 may include a visual display device 124, a keyboard 126 and/or a pointing device 127, such as a mouse. Each computing device 100 may also include additional optional elements, such as one or more input/output devices 131a-131b (generally referred to using reference numeral 131), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 101 communicates with main memory 122 via a system bus 150 (described in more detail below). FIG. 1C depicts an embodiment of a computing device 100 in which the processor communicates directly with main memory 122 via a memory port 103. For example, in FIG. 1B the main memory 122 may be DRAM.

FIG. 1C depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1C, the processor 101 communicates with various I/O devices 131 via a local system bus 150. Various busses may be used to connect the central processing unit 101 to any of the I/O devices 131, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1C depicts an embodiment of a computer 100 in which the main processor 101 communicates directly with I/O device 131b via HyperTransport, Rapid I/O, or InfiniBand. FIG. 1C also depicts an embodiment in which local busses and direct communication are mixed: the processor 101 communicates with I/O device 131b using a local interconnect bus while communicating with I/O device 131a directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software 121 related to providing an agent, such as a safe agent, as described herein. The computing device 100 may further comprise a storage device 128, such as one or more hard disk drives or redundant arrays of independent disks, for storing an operating system and other related software, and for storing application software programs such as any program related to an agent 121 as described herein. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 131a-131n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 131 may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 131a-131n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 131 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGs. AugeB and 1C typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. In some embodiments, the computing device may include any type and form of wireless reading device, such as any Kindle device manufactured by Amazon.com Inc. of Seattle, Wash. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

B. Systems and Methods for Providing Augmented Content

FIG. 2 is a block diagram illustrating one example architecture of the augmentation server 110 as described above with respect to FIG. 1. As illustrated, the augmentation server 110 includes a handler 36, a locator 42, an analyzer 45, a generator 48, and a reference database 39. The components 36 through 45 may include a software or firmware instruction that can be stored within a tangible computer readable medium (e.g., magnetic disk drive, optical disk or solid state memory such as flash memory, or random-access memory) and executed by a processor or equivalent electrical circuits, state machines, microcode, or the like.

A source data file 30 (e.g., a web page) resides on a server (e.g., a content provider 120) on a network 140 (e.g., the Internet). The handler 36 retrieves the source data file 30 for augmentation by the augmentation server 110. The locator 42 examines the retrieved source data file 30 for comparison to data in the reference database 39. In one embodiment, the locator 42 analyzes content of the source data file 30 for keywords, searches corresponding reference data in the reference database 39, and provides the keywords and the corresponding reference data to the analyzer 45. In an alternate embodiment, rather than analyzing the source data file 30 for keywords, the locator 42 retrieves a list of keywords from the reference database 39 and enumerates through the textual content of the source data file 30 for matches.

The analyzer 45 creates associations between the keywords and the corresponding reference data found by the locator 42. The generator 48 generates an augmented data file 50 by embedding the associations created by the analyzer 45 in the source data file 30. The generator 48 embeds associations by generating intelligent tags for the keywords, and augmenting the keywords with the intelligent tags. In one embodiment, an intelligent tag is an alphabetic and/or numeric string that identifies its associated keywords, and/or reference data, and optionally includes an unique identification number (hereinafter called the association ID). The generator 48 inserts the generated intelligent tags into the source data file 30 to generate the augmented data file 50. Web pages with the integrated intelligent tags are called augmented web pages. Keywords with the integrated intelligent tags are called augmented keywords. The generator 48 also stores the identified keywords and/or the associations in a database for later references.

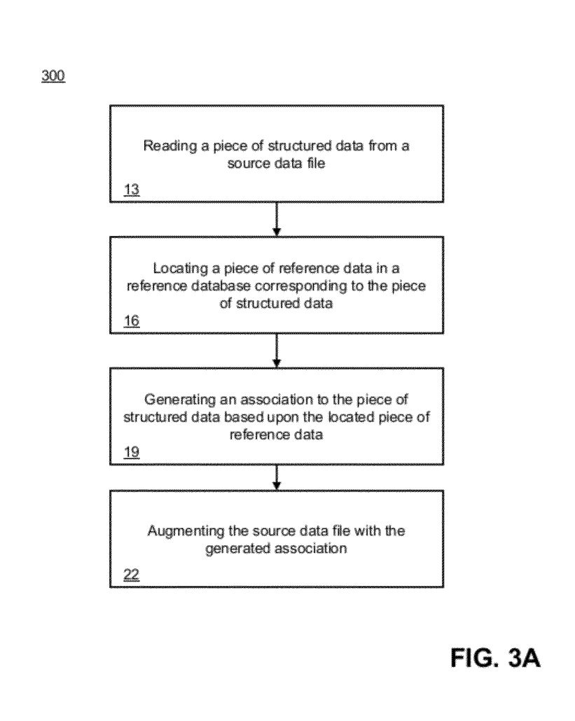

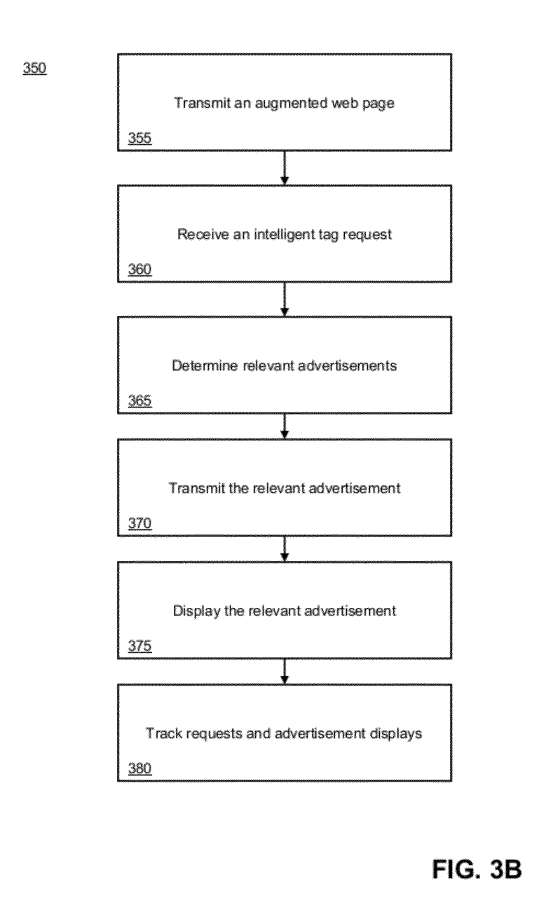

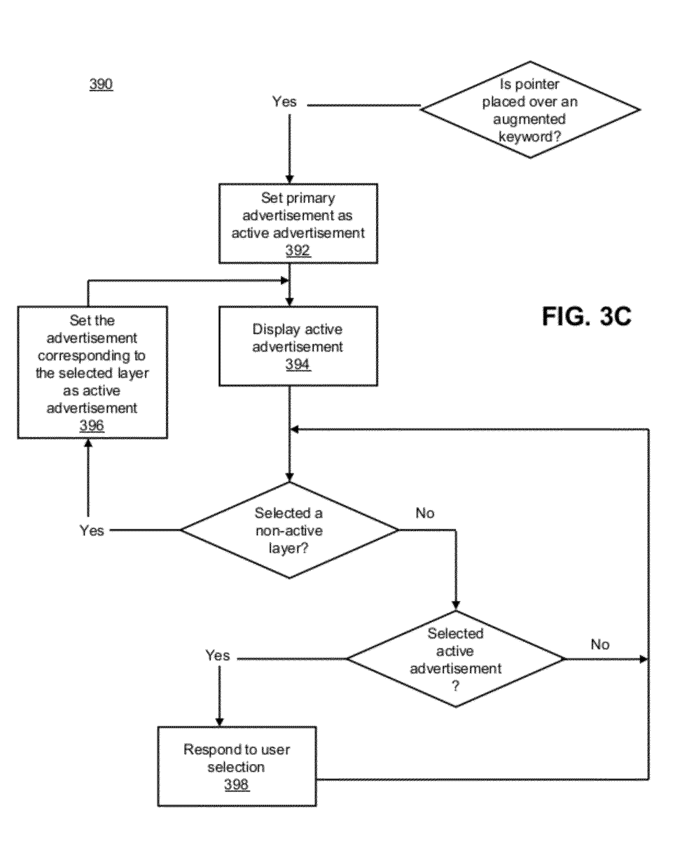

The resulting augmented data file 50 is returned to the handler 36 to reside at a Universal Resource Locator (URL) address on the network 140 (e.g., at the content provider 120 from which the source data file 30 is retrieved). In one embodiment, the handler 36 also receives requests (or signals) from client computers 130 indicating user interactions with the augmented data file, and transmits to the client computers 130 related advertisements for display through layered augmentation. Layered augmentation is described in detail below with respect to FIGS. 3A through 3C. The handler 36 retrieves the activated keywords (e.g., from the requests), and determines one or more relevant advertisements from an advertising database (not shown) that matches the keywords and/or the associated reference data. In one embodiment, rather than transmitting the related advertisements, the handler 36 transmits addresses (e.g., URLs) of the relevant advertisements to the requesting client computer 130. The client computer 130 resolves the addresses to retrieve the advertisements.

The reference database 39 stores reference data such as types of advertisements (e.g., television advertisements), categories of advertisements (e.g., storage rental, home equity loan), and/or information about specific advertisements (e.g., associated keywords, format information, price the advertiser is willing to pay, and URL of the advertisement). The reference database 39 may be a relational database or any other type of database that stores the data, such as a flat file. In one embodiment, the reference database 39 is a web enabled reference database supporting remote calls through the Internet to the reference database 39.

The components of the augmentation server 110 can reside on a single computer system or several computer systems located close by or remotely from each other. For example, the analyzer 45 and the generator 48 may reside on separate web servers, and the reference database 39 may be located in a dedicated database server. In addition, any of the components or sub-components may be executed in one or multiple computer systems.

Web pages (or web browsers) can provide additional information to viewers. For example, when a user places a mouse over a link label of a hyperlink, a web browser displays the associated destination URL (e.g., on a status bar of the web browser). As another example, when a user places a pointer over a keyword, the web browser may generate a pop-up dialog box, and display relevant information (e.g., an explanation of the keyword). The process of providing additional information to web page viewers is called augmentation.

A keyword (or phrase) often has multiple aspects of related information, each having multiple aspects of related information. For example, the key phrase “digital camera” is related to its history, underlying technology, and available products and services. A specific product related to digital camera has related information such as product description, customer review, and competing products. Usually only one aspect of the related information is provided through augmentation due to limited display space.

Multiple aspects of related information can be arranged and provided to viewers through layered augmentation. Each aspect of related information can be assigned to one specific layer of the layered augmentation. Viewers can navigate among the multiple aspects of related information by accessing the different layers of the layered augmentation without leaving the web page. For example, the augmented information can be displayed in a multi-layered dialog box. A viewer can navigate among different layers by selecting associated tabs displayed in the dialog box in which each tab is associated with a layer. Alternatively, the multiple layers may be stacked in a manner similar to windows in Microsoft Windows™ Operating System. The stacked layers may be arranged in a horizontal, vertical, or cascade style, showing a small exposed portion of each layer, such as a title area or a corner area. Navigation between each layer in the stack can be through selection of that small exposed portion of the layer within the stack. The process of providing additional information (or resources) through multi-layered dialog box and the multi-layered dialog box are collectively called layered augmentation.

FIGS. 3A through 3C are flowcharts collectively illustrating an example process (or method) for augmenting web pages and providing viewers of augmented web pages with related advertisements through layered augmentation. In one embodiment, the illustrated method (or either of its sub-methods 300, 350, and 390) is implemented in a computing environment such as the computing environment 100. One or more portions of the method may be implemented in embodiments of hardware and/or software or combinations thereof.

By way of example, the illustrated method may be embodied through instructions for performing the actions described herein and such instrumentations can be stored within a tangible computer readable medium and are executable by a processor. Alternatively (or additionally), the illustrated method may be implemented in modules like those in the augmentation server 110 described above with respect to FIG. 2 and/or other entities such as the content providers 120 and/or the client computers 130. Furthermore, those of skill in the art will recognize that other embodiments can perform the steps of the illustrated method in different order. Moreover, other embodiments can include different and/or additional steps than the ones described here.

FIG. 3A illustrates an example process (or method) 300 for augmenting web pages. As illustrated in FIG. 3A with reference to components of the augmentation server 110 in FIG. 2, at an appropriate starting terminus 10, the method 300 begins by reading a piece of structured data from a source data file 30 at a block 13 (e.g., through the handler 36). The source data file 30 may be one designated by an input uniform resource locator (URL) address or by any suitable means to designate a resource. Upon opening the source data file 30, the method 300 may optionally identify the type of content on the page with a content identifier such as a MIME header (e.g., through the locator 42). In one embodiment of the invention, the method 300 merely searches for the presence of a piece of reference data (e.g., through the locator 42), either informed by the content identifier or by simply searching an occurrence of a piece of well structured data (e.g., a keyword) within the source data file. In addition, once the source data file 30 is open, the method 300 has its content available for comparison to reference data in the reference database 39. Other methods and examples to read a piece of structured data from the source data file are described in U.S. application Ser. No. 12/033,539, filed on Feb. 19, 2008, the content of which is incorporated by reference in its entirety.

At a block 16, the method 300 locates one or multiple pieces of reference data in the reference database 39 corresponding to the piece of structured data read in the source data file 30 (e.g., through the locator 42). In one embodiment, the locator 42 searches for reference data in the reference database 39 that match the piece of structured data by making function calls to the reference database 39. In one embodiment, the structured data are keywords, and the reference data also contain keywords.

Keywords are a facile and efficient means of generating layered augmentation. In addition to or instead of using keywords, one embodiment uses a “fuzzy expert” or a neural network analysis of the source data file 30, such as by a natural language search of the source data file 30 to generate a distinct identifier for the content in the source data file 30. One advantage of a natural language search is the ability to better place content in context making links more contextually appropriate, for instance, security might relate to security of a physical plant such as security of a residence in one source data file 30 in one context and security of a website in another. In one embodiment, the method 300 determines a context of the keywords and/or the source data file 30 based on statistical modeling (e.g., through the locator 42). For example, a context can be assigned a pre-defined set of terms which acts as a fingerprint for the context (hereinafter called context fingerprint). The locator 42 can compare the context fingerprints associated with a collection of contexts with the terms within the source data file 30 to determine a percentage match for each context in the collection. Where a high percentage match is achieved (e.g., exceeding a pre-defined percentage match threshold), the locator 42 determines that the associated context is the context for the source data file 30. Alternatively or in conjunction, the locator 42 may determine the context associated with the highest percentage match as the context for the source data file 30. The context can be used to locate corresponding reference data and/or related resources.

At a block 19, the method 300 generates an association to the piece of structured data based upon the located matching reference data (e.g., through the analyzer 45). In one embodiment, a piece of reference data includes an identifier such as a keyword, a context, a unique identification number, and/or associated URL address(es) of intended destination resource(s) based upon the occurrence of the corresponding keywords in the source data file 30. Generating an association means to associate the piece of structured data located in the source data file 30 with the located reference data in the reference database 39. The generated association might optionally include additional identification codes such as an association ID. The method 300 then augments the original source data file 30 with the generated association at a block 22 to generate an augmented data file 50 (e.g., through the generator 48).

In one embodiment, the method 300 expresses the association as intelligent tags (e.g., through the generator 48). The method 300 generates intelligent tags for the located keywords and tags the keywords with the generated intelligent tags. The intelligent tags contain information about the associated keywords such as the keyword and related context, and information about the associated reference data such as IDs that uniquely identify the reference data in the reference database 39. For example, the intelligent tags may contain requirement (or preference) information about advertisements (or other types of resources) to be associated with the keyword, such as types of advertisements and a minimum advertisement fee. In one embodiment, the intelligent tags also format the augmented keywords differently than the other textual content in the augmented web pages. Having generated the augmented data file 50, the method 300 then terminates at a block 25.

In one embodiment, the augmentation server 110 (or the content providers 120) also augments the web pages by including computer code (hereinafter called client code) to monitor and report viewers' interactions with the augmented keywords. The computer code can be in any computer language, such as JavaScript. Additional functions of the client code are described in detail below with respect to FIGS. 3B and 3C.

The augmented data file 50 can be delivered (or transmitted) to client computers 130 for display through a web browser to viewers to provide related resources through layered augmentation. The delivery of the augmented data file 50 and the process to provide layered augmentation is described in detail below with respect to FIGS. 3B and 3C. For purpose of illustration, the method is described in terms of web pages augmented with advertisements, even though the disclosed embodiments apply to other types of augmented data file and resources.

Referring now to FIG. 3B, a flowchart illustrating an example process (or method) 350 for providing layered augmentation to viewers of augmented web pages. As illustrated, the method 350 transmits 355 an augmented web page to a client computer. For example, a user of the client computer 130 may enter the URL of an augmented web page (or the corresponding original web page) in the address bar of a conventional web browser (e.g., Microsoft Internet Explorer™, Mozilla Firefox™, or Apple Safari™) The web browser of the client computer 130 (hereinafter called the client web browser) resolves the URL and transmits a request for the web page to a corresponding content provider. Responding to the request, the content provider transmits 355 the augmented web page to the client web browser for display. In one embodiment, the client web browser displays augmented keywords in a double underline style and/or in a color distinctive from text that is not augmented in the augmented web page.

The method 350 receives 360 an intelligent tag request from the client computer 130. As described above with respect to FIG. 3A, the augmented web page contains client code that monitors user interactions with augmented keywords. In one embodiment, if the user moves a pointer (e.g., a pointer controlled by a mouse, navigation button, or touchpad) over (a mouse-over) an augmented keyword (the activated keyword), the client code (which may be integrated with the web browser, for example, as a plug-in applet) generates an intelligent tag request and transmits the request to the augmentation server 110. The request indicates the mouse-over user activity to the augmentation server 110. The request may contain information that uniquely identifies the activated keyword (e.g., an association ID), and/or other information such as the activated keyword itself

The method 350 determines 365 advertisements relevant to the activated keyword for the received request based on the keyword and/or the associated reference data. In one embodiment, the augmentation server 110 extracts the keyword and/or related context from the request, retrieves the associated reference data from the reference database 39, and determines 365 the relevant advertisements by searching in an advertisement database using the keyword and/or requirements set forth in the associated reference data (e.g., advertisement category, context, fee requirements, etc.).

In one embodiment, the method 350 determines 365 the advertisements that match the best (e.g., matching the activated keyword and/or satisfies the most number of reference requirements) as the relevant advertisements. In another embodiment, the method 350 determines 365 relevant advertisements based on a context of the augmented web page and/or the activated keyword. For example, for a key phrase “digital camera” in an article about digital camera, the method 350 may determines the following resources as relevant: a product review of a digital camera in CNET.com, a collection of user reviews at Buy.com, and a selection of similar digital cameras. The context can be determined when the activated keyword is identified in method 300.

In one embodiment, the method 350 determines a sequence for the related advertisements. The top advertisement in the sequence (also called the default advertisement or the primary advertisement) is the advertisement being displayed on the top layer of the layered augmentation. The lower ranked advertisements (also called secondary advertisements) are made available on lower layers of the layered augmentation. In one embodiment, the method 350 uses a bidding system to determine related advertisements sequence. For example, for a key phrase “digital camera,” there may be multiple related advertisements (e.g., advertisements for different brands or models of digital cameras), each having a bid (or budget or cost) for the key phrase. The method 350 may determine a sequence of the advertisements based on their bids, the one with the highest bid ranked the highest and so on.

In another embodiment, the method 350 may determine the sequence of multiple advertisements based on factors other than bidding prices. For example, the method may consider factors such as relationships among the multiple advertisements (e.g., prioritizing video advertisements over text ones), prior user interactions with the advertisements (e.g., prioritizing advertisements with higher interacting rate), and contexts of the augmented keyword (e.g., prioritizing advertisements from retailers or service providers having branches near a geographical context of the keyword and/or the augmented web page, or geographic locations of a substantial portion of viewers of the web page).

Further, specific sequences may be set for specific keywords and/or parties (e.g., content providers, advertisers, users). For example, if the keyword(s) is a music artist (or band, album) name, the method 350 may make available his songs (e.g., playback through an embedded music player) on the top layer and other resources on lower layers. As another example, if the keyword(s) is a location name (e.g., Yellowstone National Park), the method 350 may make available the relevant map (e.g., MapQuest™ Map) on the top layer. As noted above, the resources made available through the layered augmentation need not to be advertisements and can be related contents such as related articles, videos, images, music, to name only a few. For example, a content provider may specify that the layered augmentations in its web pages make available a set of links to its other relevant web pages (e.g., within the same website) where the keyword(s) being augmented is cross-indexed.

In one embodiment, viewers can set their preferences to determine a preferred sequence for the layered augmentation. For example, a viewer may prefer video advertisements while another may disfavor them (e.g., due to bandwidth constrains at receiving device). As a result, the method 350 may place video advertisements higher on a sequence for the first viewer, while not consider video advertisements for augmentation for the second viewer. Viewer preferences can be stored in a database such as the reference database 39 along with other viewer related data (e.g., profile data).

The method 350 transmits 370 the relevant advertisements to the client computer 130 for display. In one embodiment, the method 350 retrieves the advertisements from an advertisement database, and transmits 370 them to the client web browser (or the client computer) for display. Alternatively, the method 350 may transmit references of the advertisements (e.g., their URLs) to the client web browser for retrieval.

In one embodiment, the method 350 generates computer code (hereinafter called the advertisement code) to facilitate user interaction with the advertisements. Similar to the client code, the advertisement code can be in any computer language, such as JavaScript. The advertisement code may display the relevant advertisements in a multi-layered dialog box (or popup box) when the viewer moves a pointer over the activated keyword. The method 350 transmits the generated advertisement code along with the related advertisements to the client web browser. In one embodiment, the advertisement code is a part of the client code, and is integrated in the augmented web page when the page is generated.

The client web browser displays 375 the relevant advertisements in a layered dialog box proximate to the activated keywords (or the position where the mouse-over is occurring) as an in-page overlay. In one embodiment, the client web browser utilizes the advertisement code to display the advertisements in a multi-layered dialog box. The advertisements are displayed according to their sequence. In one embodiment, only the top advertisement is displayed and the lower ranked advertisements are represented by selectable tabs. An example process of the operation of the advertisement code and the client code is described in detail below with respect to FIG. 3C.

Referring now to FIG. 3C, a flowchart illustrating an example process (or method) 390 of the client code and/or the advertisement code. As illustrated, the method 390 determines whether a pointer is positioned over an augmented keyword (the activated keyword), and if so, sets 392 the primary advertisement as the active advertisement, and displays 394 the active advertisement in a multi-layered dialog box overlaying the augmented web page in a position proximate to the activated keyword or the mouse-over. The multi-layered dialog box also displays multiple selectable (e.g., clickable) tabs representing the lower layers. The viewer can select a tab to request the multi-layered dialog box to display the corresponding layer. If the user selected a tab, the method 390 sets 396 the advertisement corresponding to the selected layer as the active advertisement and displays 394 it in place of the previously displayed advertisement.

The viewer can also interact with the currently displayed advertisement by selecting the advertisement. If the viewer selects the advertisement, the method 390 responds 398 to the user selection based on the nature of the user selection and the configuration of the advertisement. For example, if the user clicks on the active advertisement, the method 390 redirects the web browser to a web page related to the active advertisement. Alternatively, if the user drags a scrollbar displayed on the dialog box, the method displays different portions of the active advertisement as the user drags along the scrollbar. In one embodiment, if the viewer moves the pointer away from the activated keyword and/or the multi-layered dialog box for an extended period of time, the method 390 hides the dialog box.

Referring back to FIG. 3B, in one embodiment, rather than displaying multiple advertisements, the method 350 displays multiple aspects (or portions) of the same advertisement in the multi-layered dialog box. For example, the multi-layered dialog box may display an image and brief description of a product, and present two tabs, one for user reviews and the other for playback of a television advertisement of the product. The viewer may interact with the advertisement through the multi-layered dialog box without having to navigate away from and otherwise leave the current web page the viewer is interacting with in the web browser. For example, if the advertisement contains video, the multi-layered dialog box may overlay the video with video controls (e.g., forward, rewind, play/pause, volume, etc.). The multi-layered dialog box may also provide functional resources such as web searches, enabling viewers to conduct web searches and/or review search results without leaving the augmented web page.

The method 350 tracks 380 the received requests, the advertisements displays, and/or the user's interactions with the advertisements. These activities may be logged in a database (e.g., the reference database 39) or reported to another device or person (e.g., via electronic mail).

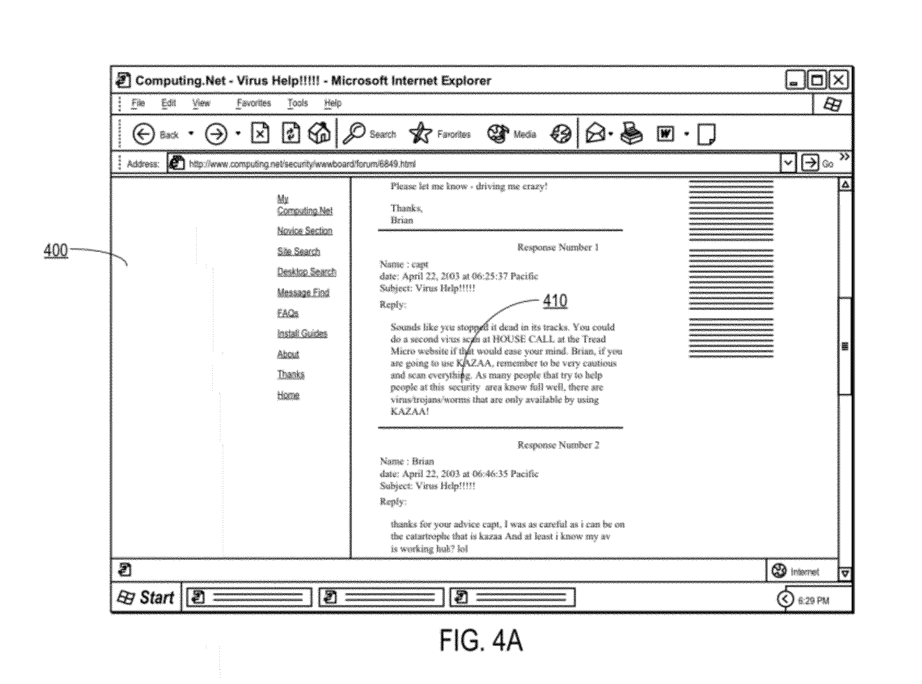

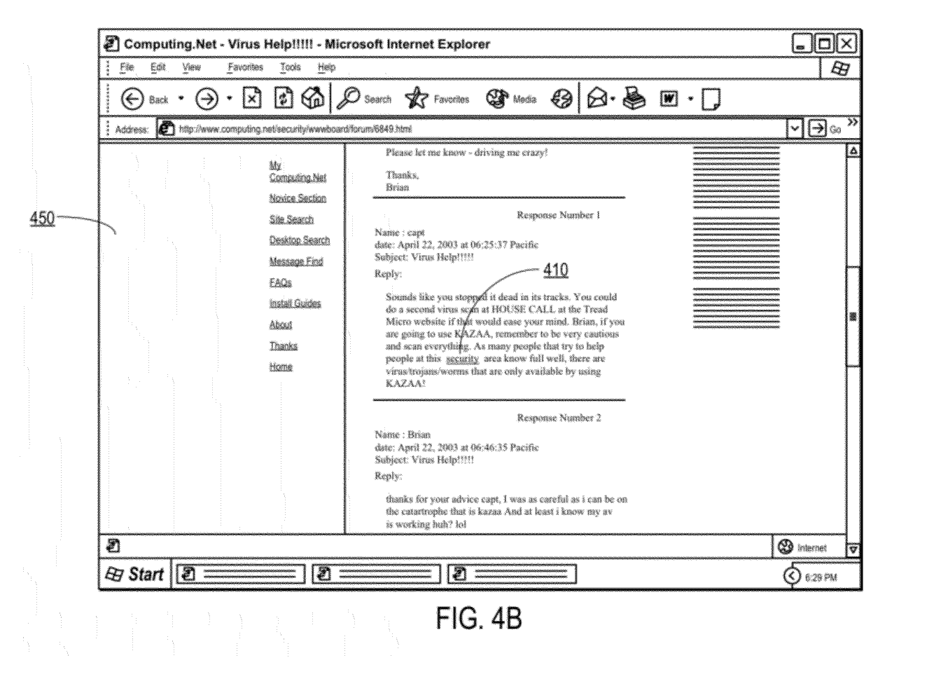

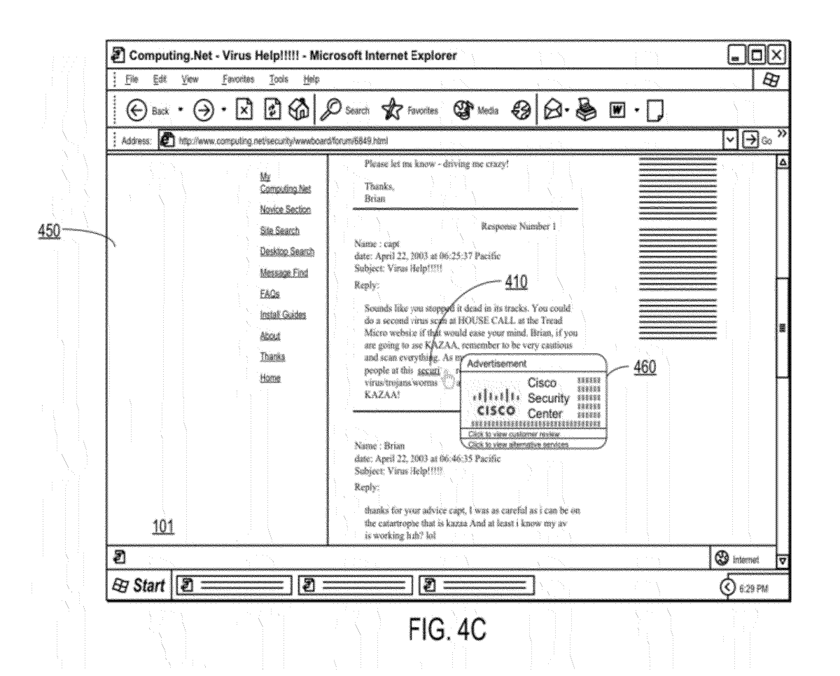

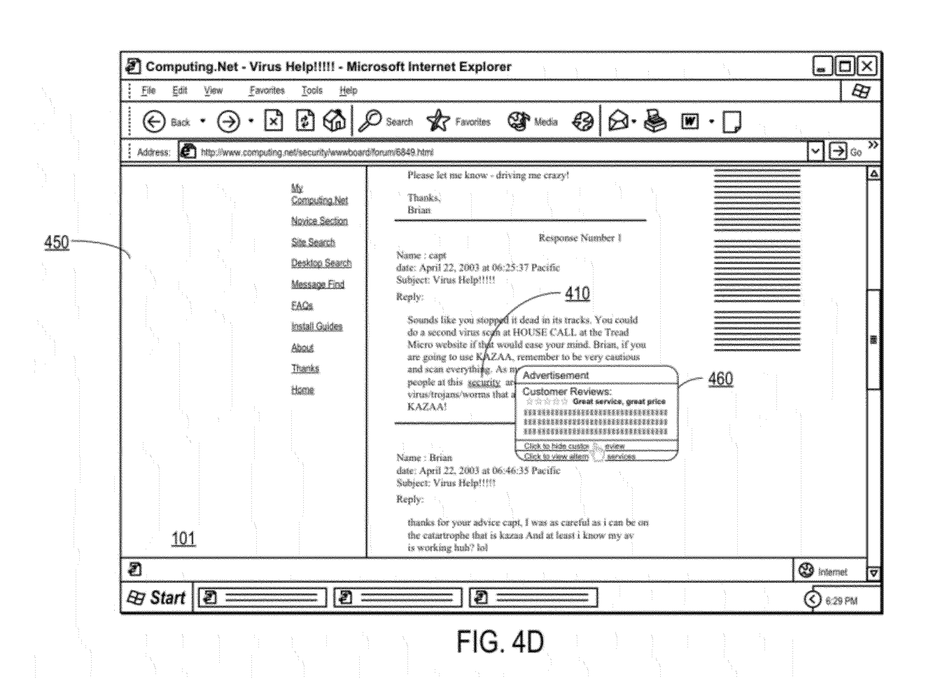

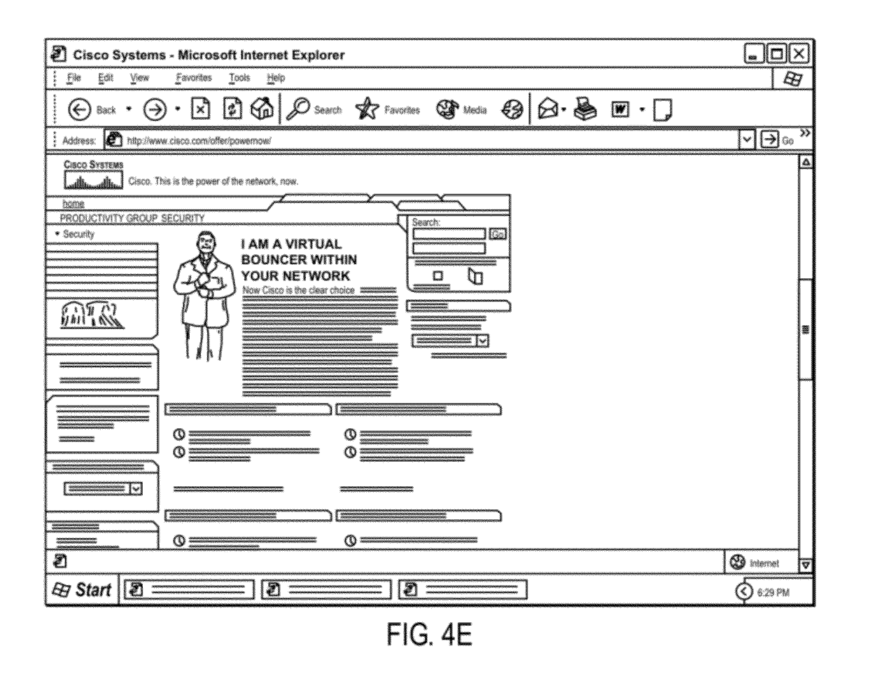

The methods described above with respect to FIGS. 3A through 3C are illustrated below in an example together with accompanying screenshots in FIGS. 4A through 4E. Initially, the augmentation server 110 retrieves a web page 400 for augmentation. The web page 400 may contain textual content of any subject. FIG. 4A shows an example of the web page 400 as displayed in Microsoft Internet Explorer™ As shown in FIG. 4A, the web page 400 is retrieved from website www.computing.net and contains a paragraph about computer virus.

The augmentation server 110 reads 13 the web page 400 for keywords. The augmentation server 110 identifies the keyword “security” 410 for layered augmentation. The augmentation server 110 locates 16 a piece of reference data matching the keyword “security” 410 and determines a context of computer security for the keyword 410. The piece of reference data includes an advertisement category for computer security services. The augmentation server 110 generates 19 an association of the keyword “security” 410 and the located piece of reference data.

The augmentation server 110 augments 22 the web page 400 by generating an intelligent tag encoding the generated association, and integrating the intelligent tag in an augmented web page 450. The augmentation server 110 also includes in the augmented web page 450 JavaScript code (client code) that captures user interactions with the augmented keyword 410.

A web browser running on a client computer 130 retrieves the augmented web page 450 and displays it to a user (e.g., responding to the user entering an URL of the web page 400 or 450 in the address bar of the web browser). FIG. 4B illustrates a screenshot of the augmented web page 450 as displayed on an Internet Explorer™ web browser after it is retrieved by the browser. It is noted that in FIG. 4B the augmented keyword 410 is displayed in a double underline style to distinguish from conventional hyperlinks that are single underlined.

Subsequently, the user may move a pointer (e.g., controlled by a mouse, stylus, or touchpad) over the double underlined augmented keyword 410 (the activated augmented keyword). This user action is also referred to as a mouse-over. Detecting the mouse-over, the embedded JavaScript code (the client code) in the augmented web page 450 (or the web browser) generates an intelligent tag request that uniquely identifies the activated augmented keyword 410 and/or the related context, and transmits the request to the augmentation server 110. The augmentation server 110 receives 360 the request, retrieves stored association of the keyword 410, and determines 365 relevant advertisements by searching for advertisements corresponding to the keyword 410 and/or the related context in an advertising database. In the present example, the augmentation server 110 determines 365 that an advertisement for Cisco security center is the relevant advertisement associated with the augmented keyword 410.

The augmentation server 110 determines a sequence of various parts of the Cisco advertisement and/or other relevant advertisements. In the present example, the augmentation server 110 determines that a description of the Cisco security center ranks top in the sequence, followed by its customer reviews, and a list of competing services.

The augmentation server 110 transmits 370 the related advertisement(s) back to the web browser for display. The augmentation server 110 also transmits JavaScript code (advertisement code) that enables layered representation of the transmitted advertisements.

The web browser (or the advertisement code) displays 375 the received advertisement(s) as an overlay in a multi-layered dialog box in proximity to the keyword 410 or the location where the mouse-over occurred. As illustrated in FIG. 4C, the user has moved a mouse pointer over the keyword 410. As a result, the web browser receives advertisements related to the keyword “security” 410 and displays them in a multi-layered dialog box 460 proximate to the pointer.

As illustrated, the multi-layered dialog box 460 displays an advertisement about CISCO security center. On the bottom of the multi-layered dialog box 460 are two tabs labeled “Click to view customer review” and “Click to view alternative services,” respectively. Note that this is consistent with the sequence of the advertisements (and/or advertisement portions) determined by the augmentation server 110. The user can navigate the advertisements within the multi-layered dialog box 460 by clicking the labeled tabs. The user can also visit the corresponding advertiser's web page by clicking the advertisement. While the user navigates within the multi-layered dialog box 460, the augmented web page 450 remains as the current web page displayed in the client web browser. The user can quickly resume browsing the rest of the augmented web page 450.

As illustrated in FIG. 4D, when the user clicks (or mouse-over) the tab labeled “Click to view customer review,” the multi-layered dialog box 460 displays customer reviews for Cisco security center. It is noted that the label on the tab representing customer review changes to “Click to hide customer review.” The user can click the tab to resume viewing the previous advertisement for Cisco security center.

As illustrated in FIG. 4E, when the user clicks the Cisco security center advertisement, the advertisement code redirects the client web browser to the advertiser's web page, in this case a web page related to Cisco security center.

C. Systems and Methods of an Ad Server Platform

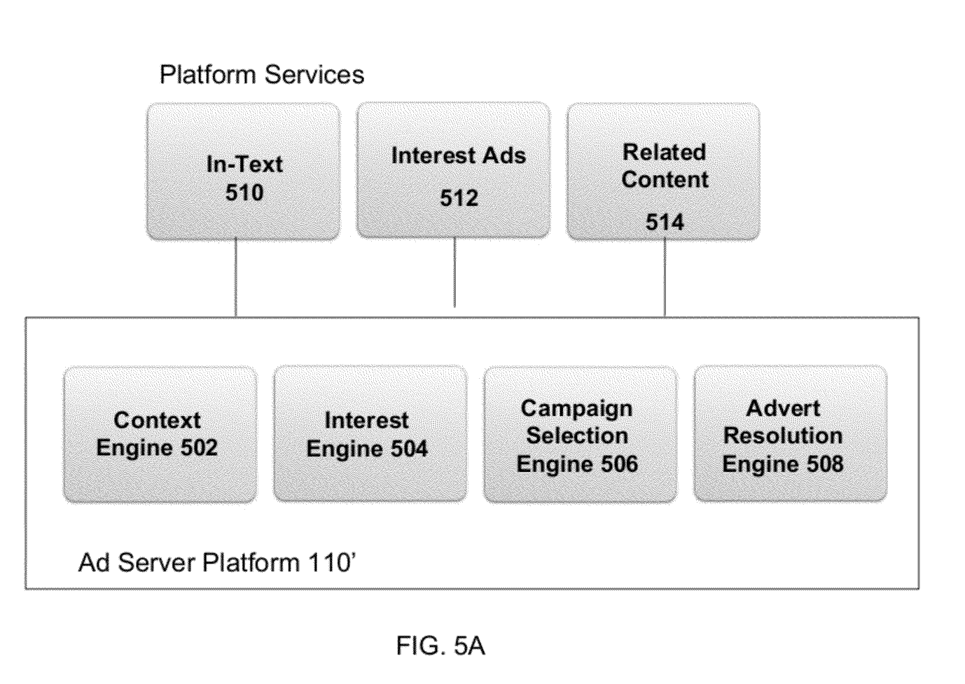

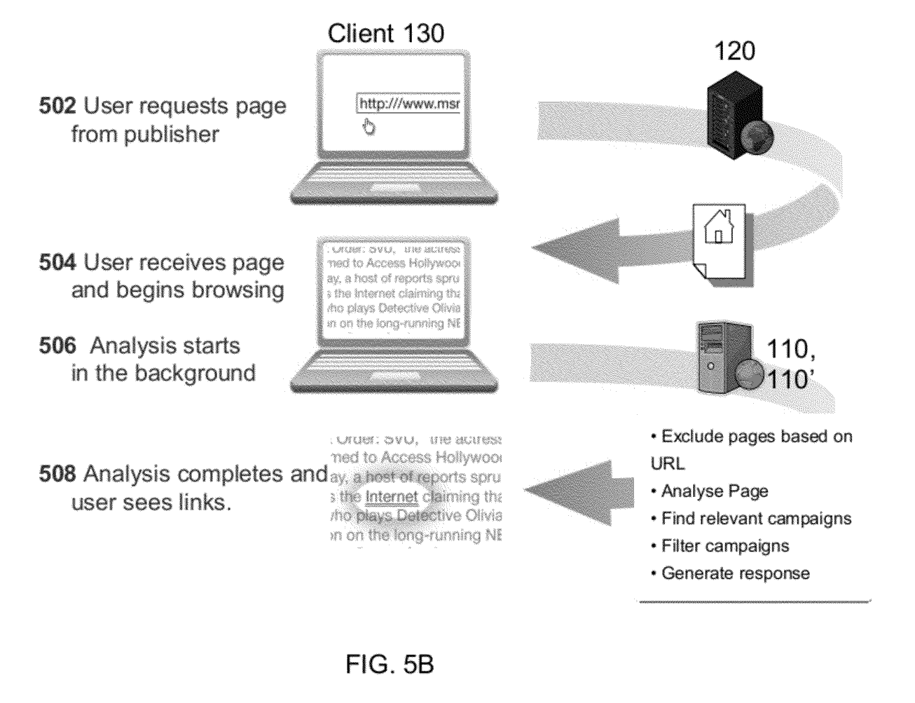

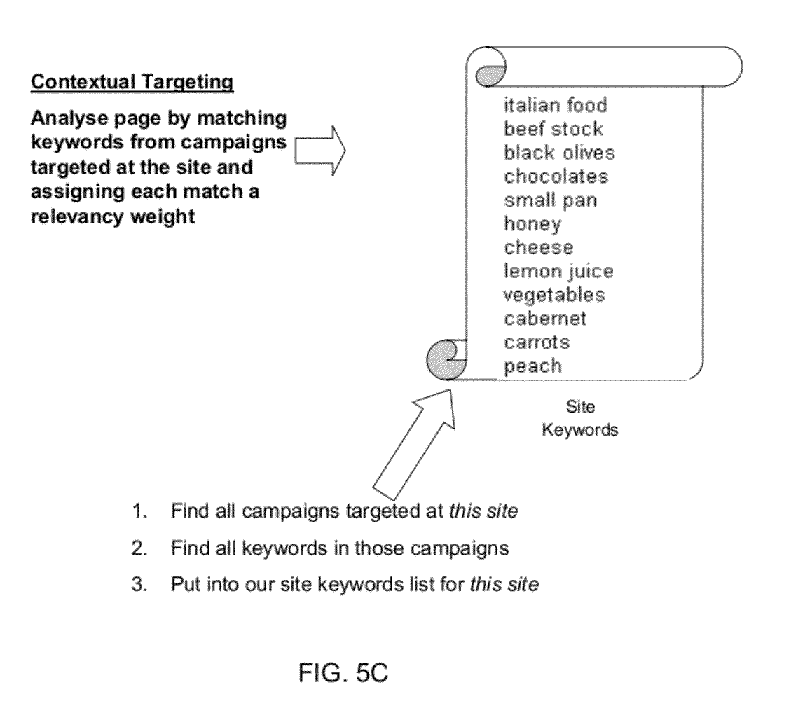

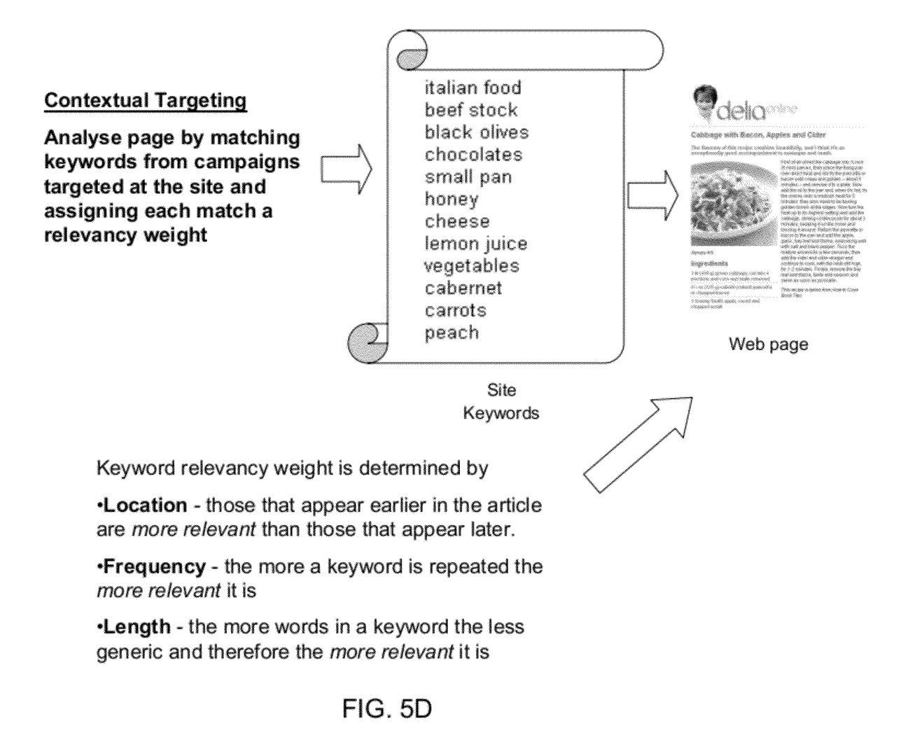

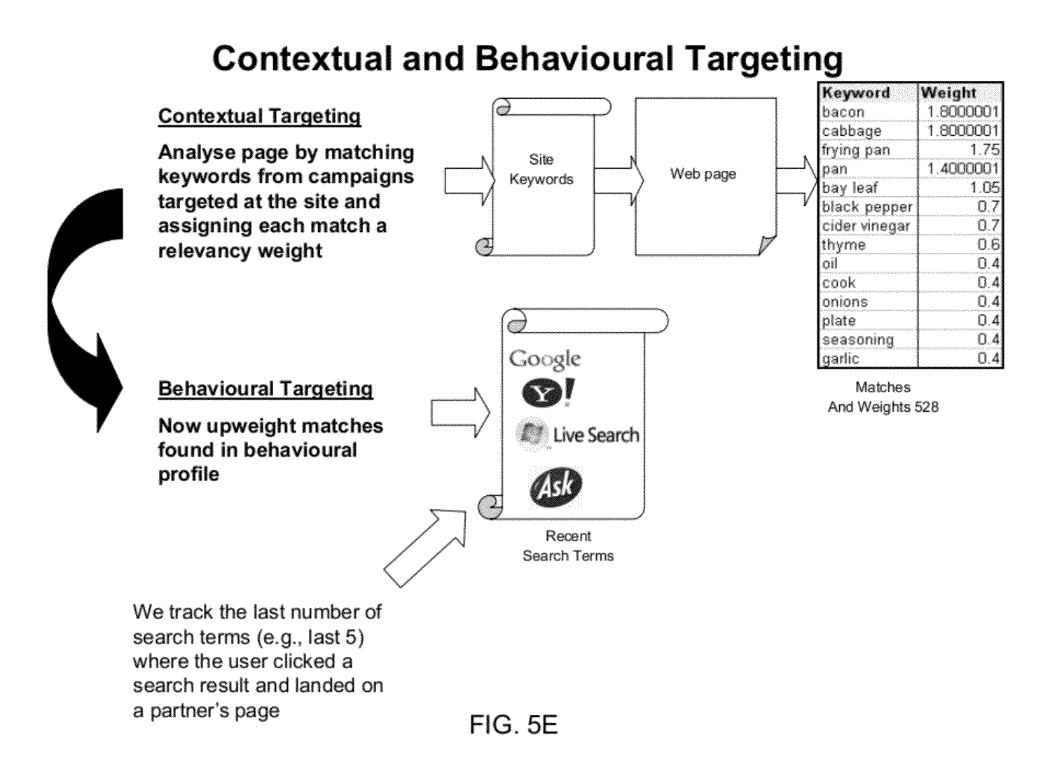

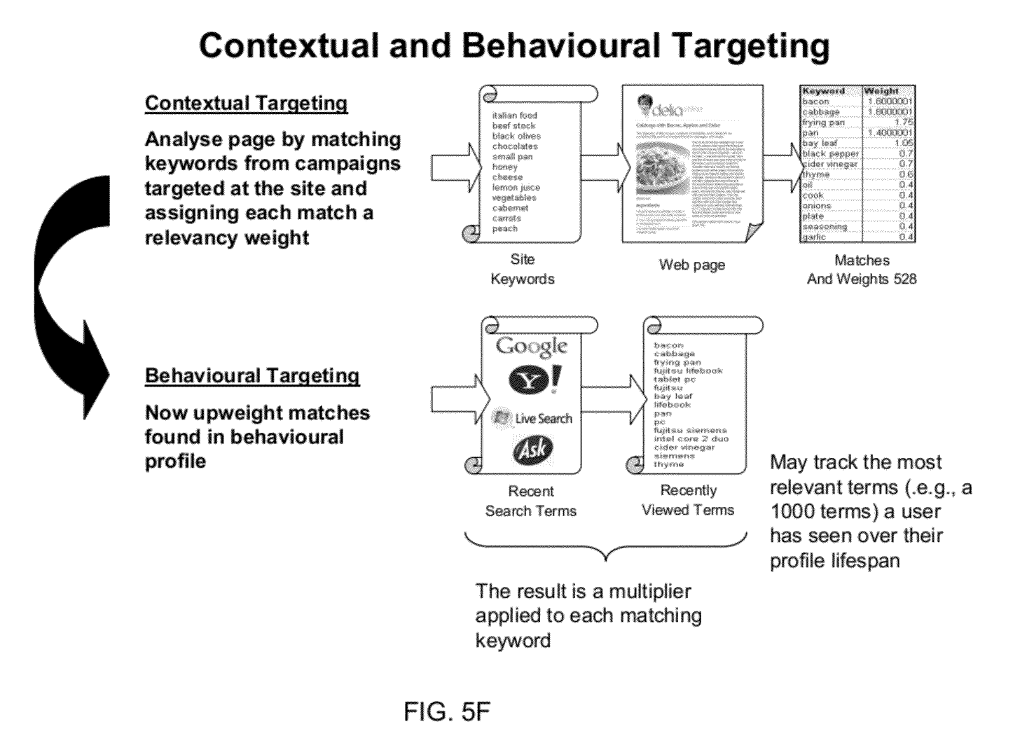

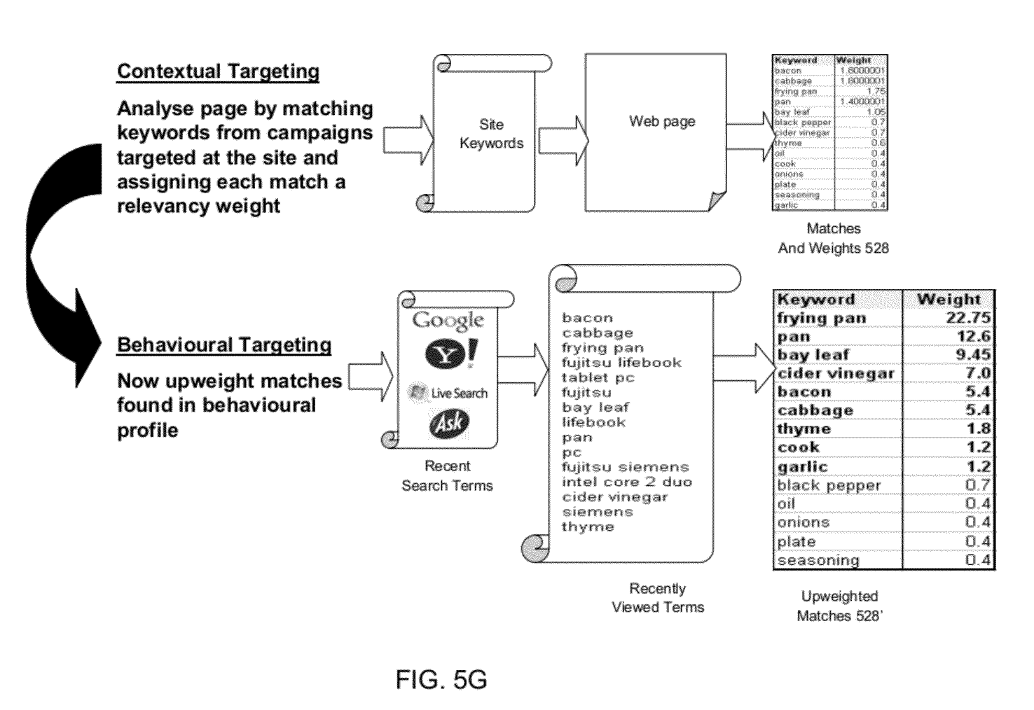

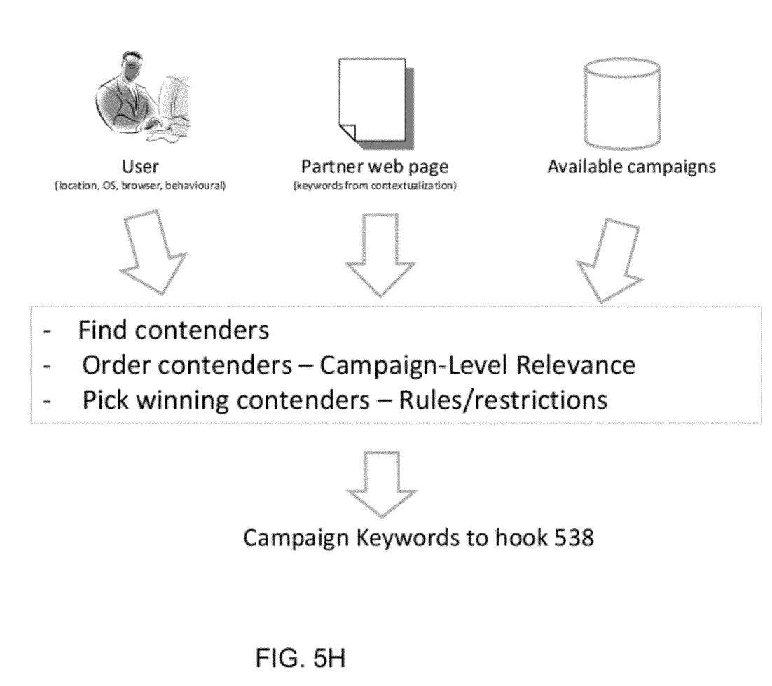

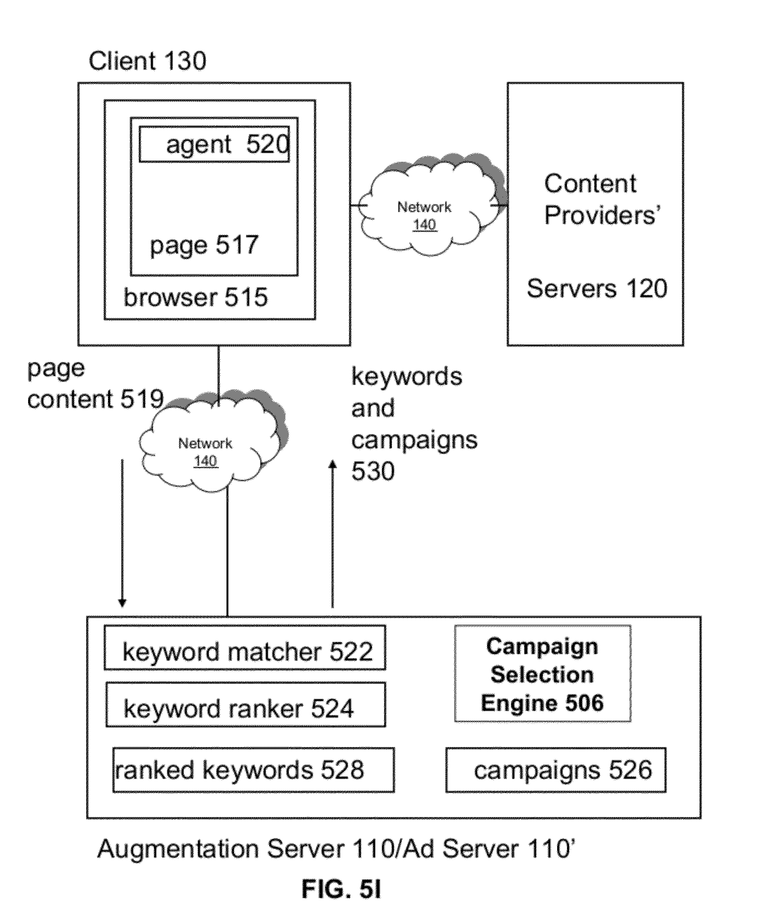

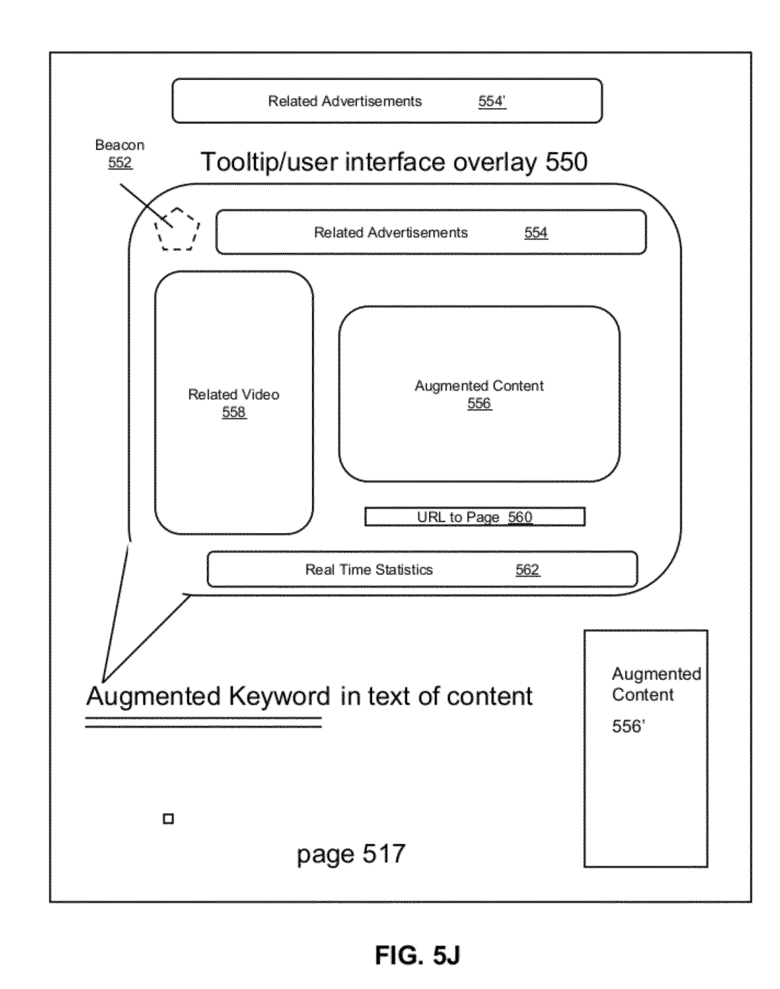

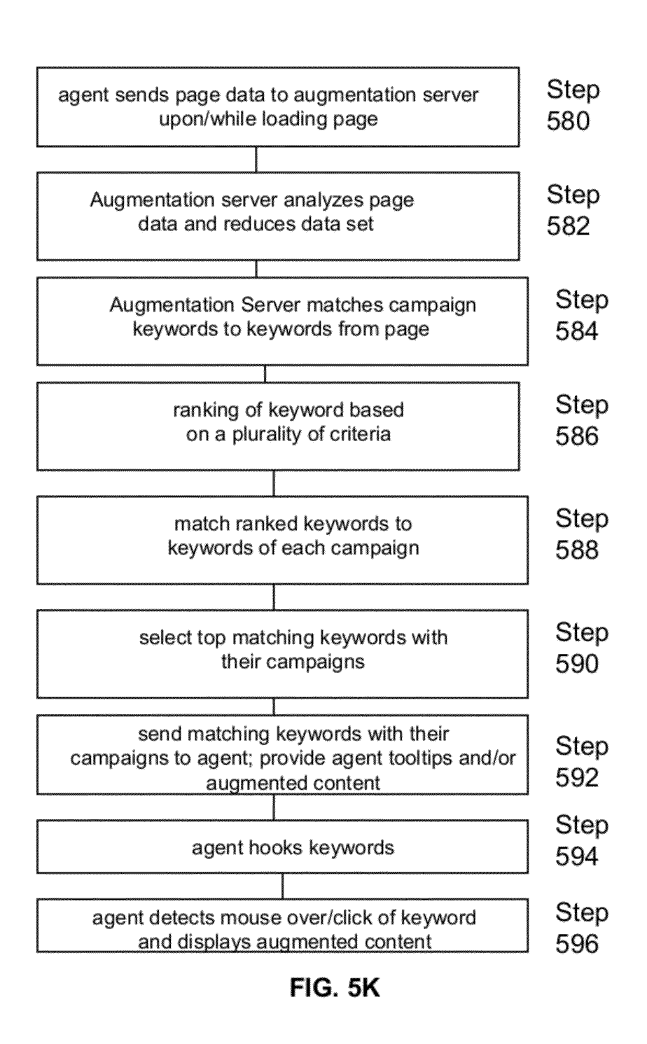

Referring now to FIG. 5A, an embodiment of an environment and systems for providing a plurality of augmented content and related services. In brief overview, an ad server platform 110′ delivers a plurality of services, such an in-text services 510, interest ads 512 and related content 514 services. The ad server platform 110′ may include a context engine 502, an interested engine 504, a campaign selection engine 506 and/or an advert resolution engine. The ad server may include or further include any embodiments of the augmentation server 110 described herein.

The ad server platform 110′ may comprise any combination of modules, applications, programs, libraries, scripts or any other form of executable instructions executing on one or more servers. The ad server platform 110′ may provide services directed to advertisers to reach a plurality of users across a plurality of publisher websites, such as content providers 120. The services of the ad server platform 110′ may combine the precise word targeting with delivery of rich media and video content. The ad server platform 110′ may provide services directed to publishers to received additional advertising revenue and real-estate with adding more clutter on their web-sites. The ad server platform provides a user controlled environment, allowed the user to view augmented content, such as advertising, only when these choose to via mouse interaction over a relevant word of interest—a keyword. As such, an ad impression may be pre-qualified in that a user must choose to view the ad by moving their mouse over or clicking on a word or phrase of interest. This may be referred to as user-initiation impressions.

The ad server platform may provide in-text advertising services 510. In-text services reads web pages and hooks words and word-phrases dynamically and in real time. The hooked words may be linked or hyperlinked to augmented content in any manner. In one embodiments, the words are double underlined but any type of indicator may be used such as a single underline or an icon. In some embodiments, the code for in-text services is installed by publishers into their sites and does not require any additional code, adware or spyware to be downloaded or uploaded by a user. When a user mouses over or clicks on hooked (e.g., double underlined) word or phrase, the code display a user interface overlay, sometimes referred to as a tooltip, on the web page and near the hooked word or phrase.

The ad server platform may provide interest ad services 512. The interest ad services identifies words of interest within a web page to deliver advertisements that are related to these words of interest. The interest ad service may identify the words on the page to analyze those words to determine which words are core or central to that page. These set of core word are keywords to identify one or more ad campaigns relevant to those keywords and the user's interests. This may minimize wasted impressions and deliver and advertising experience that relates more directly to the user's interest.

The ad server platform may provide related content services 514. The related content services may provide, create or generate an automated linking system that conveniently delivers relevant additional content from the same or different publishes in the form of videos, articles and information. The related content services may read web pages and hook words and word-phrases dynamically and in real time. The hooked words may point or navigate the user through content related to the hooked words available through a website, network or portal. For example, the related content service may link a word on the page to re-circulate the user through additional content, such as other web pages, of the publisher. In some embodiments, the related content service may automatically mirror the hyperlink style of a publisher's editorial links or already provided hyperlinks. The related content services may generate or add an icon, such as search icon, that indicates that augmented content is returned or available.

In further details, the ad server platform may comprise one or more context engines 502. The context engine may comprise any type and form of executable instructions executing on a device, such as a server. The context engine may comprise any functions, logic or operations for analyzing content of a web page. The context engine may use any type and form of semantics based algorithm to determine the meaning of the keyword relevant to the content of the page, the user, the web-site, the publisher and/or the campaign. The context engine may determine the intended structure and meaning of words, phrases, sentences or text in the content of the page. The context engine may analyze the text in the content to determine any characters, text, strings, words, terms and/or phrases, or any combinations thereof, that match or correspond to any characters, text, strings, words, terms and/or phrases, or any combinations thereof of any one or more campaigns. The context engine may analyze the content of the page for keywords from campaigns targeted at the web-site, publisher or content provider of the page. The context engine may determine any type of metrics on the content of the web page and of keywords of targeted campaigns of the web page. The context engine may use any type and form of algorithm to determine a keyword relevancy weight such as by location of the keyword, the frequency of the keywords and the length of the keyword. For example, for location weighting, those keywords that appear earlier in the content may be considered more relevant than those that appear later. For frequency relevancy, the more a keyword is repeated within the content, the more relevant the keyword may be considered. For length relevancy, the more words in a keywords the less generic the keyword may be and the more relevant the keyword may be considered.

The ad server platform may comprise one or more interest engines 504. The interest engine may comprise any type and form of executable instructions executing on a device, such as a server. The interest engine may comprise any functions, logic or operations for tracking and storing user information and/or behavior to a behavioral profile. The interest engine may track and store the user's location, operating system and/or browser. The interest engine may track a predetermined number of keywords a user has seen over a certain time period. The interest engine may track a predetermined number of relevant terms a user has viewed over a certain time period. The interest engine may track the a predetermined number of searches for which a user clicked a search result and landed on the content providers web-site or web. The interest engine may store the recent search terms and/or recently viewed terms into a behavioral profile for the user. The ad server platform, context engine and/or interest engine may change the weighting of keywords in content of a page responsive to any information stored in any behavioral profiles. For example, The ad server platform, context engine and/or interest engine may use a multiplier to upweight or downweight one or more keywords. The ad server platform may comprise one or more campaign selection engines 506. The campaign selection engine may comprise any type and form of executable instructions executing on a device, such as a server. The campaign selection engine may comprise any functions, logic or operations for selecting or matching a campaign to a set of one or more keywords identified and/or weights for content of a page. The campaign selection engine may identify and select a campaign from a plurality of campaigns. The campaign selection engine may identify and select a first set of campaigns from a plurality of campaigns that meet a first threshold or criteria. From the first set of campaigns, the campaign selection engine may order or rank these campaigns using any type and form of algorithms. In some embodiments, the campaign selection engine may provide a campaign-level relevance of the keywords. The campaign selection engine may determine a relevance number or weighting for each campaign relative to the weighted keywords. In some embodiments, each campaign may provide a priority to keywords, web-pages or publishers. In some embodiments, each campaign may provide a relevance weighting to keywords, web-pages or publishers. The campaign selection engine may also comprise any set of one or more rules or restrictions for either changing the ranking, keeping a campaign or removing the campaign. Based on applying these rules and/or restrictions, the campaign selection engine selects from the first set of one or more companies a second set of one or more campaigns to use for augmenting the identified keywords on the web-page.

The ad server platform may comprise one or more advert resolution engines 508. The advert resolution engine may comprise any type and form of executable instructions executing on a device, such as a server. The advert resolution engine may comprise any functions, logic or operations for resolving the advertisement to use for a hook. For each advertisement, the advert resolution engine may determine whether the advertisement is a backfill or to be obtained from a backfill network. If the advertisement is backfill, the advert resolution engine calls or communicates with the backfill provider's servers. For example, the advert resolution engine may include one or more handlers designed and constructed to communicate with a particular backfill provider. When an advertisement is received from the backfill provider or when the advertisement if not coming from a backfill, the advert resolution engine may perform any type and form of filtering on the advertisement, such as for making sure the ad meets any rules or restrictions for content. The advert resolution engine includes a placer for selecting an instance of a keyword to hook with the advertisement. When the advert resolution engine has checked for backfill, filters the advertisement and selected an instance to hook for all the intended advertisements, the advert resolution engine may hook the keywords. The advert resolution engine may perform these operations for content other than advertisements, such as other types of augmented content.

Referring now to FIGS. 5B through 5H, diagrams of embodiments of the functionality and operations of the ad server platform are depicted. FIG. 5b depicts an embodiment of high level overview of the process from the client perspective. FIG. 5C depicts an embodiment of contextual targeting. FIG. 5D depicts an embodiment of keyword relevancy weighting. FIG. 5E depicts an embodiment of behavioral targeting. FIG. 5F depicts a further embodiment of behavioral targeting. FIG. 5G depicts an embodiment of further weighting based on behavioral targeting. FIG. 5H depicts and embodiment of campaign selection.

Referring to FIG. 5A, at step 502, a user on a client 120 requests a page from a publisher, such as a web page of a content provider 120. At step 504, the client receives the page and the browser loads the page. The user may start browsing the web page. At step 506, an agent on the page, such as a script starts an analysis in the background. The agent may be triggered upon loading of the web page or start the analysis upon receipt and/or loading of the web page. The agent may communicate with the ad server platform to perform any of the services of in-text advertising, related content or interest ads. For example, the agent may send content from the page for the ad server platform to analyze. In the background of the user viewing or browsing the web page, the ad server platform may analyze the page, find relevant campaigns filter campaigns and generate a response to the agent for hooking the keywords and identifying or delivering the augmented content. The ad server platform may not analyze pages based on filtering certain URLs. The ad server platform may analyze the content received from the agent, perform any of the services described herein and send the keywords to hook and the corresponding augmented content, such as advertisements from a campaign. At step 508, the analysis is completed and the user sees links to keywords, such as double underlined keywords. As described herein, the user may mouse over or click the hooked keyword and have the augmented content displayed.

Referring now to FIG. 5C, an embodiment of contextual targeting is depicted. This contextual targeted may be performed by the ad server platform and performed in the background while the page is being loaded and browsed/viewed by the user. The ad server platform receives page content from the client, such as via an agent. The ad server platform analyzes the page to match keywords to campaigns targeted to the web-site, page or URL. In some embodiments, the ad server platform finds all campaigns targeted to this site, finds all keywords in those campaigns and forms or generates a site keyword list for this site. The ad server platform may match the keywords from the site keyword list to keywords in the content from the page. The ad server platform may assign each matching keyword a relevancy weight.

Referring now to FIG. 5D, an embodiment of assigning a relevancy weight to each keyword to provide contextual targeting is depicted. The ad server platform may provide a relevancy weight to each keyword of the site keyword list matching content of the web page. The ad server platform may use any type and form of metrics or combinations of metrics to determine a relevancy weight. In some embodiments, the ad server platform uses a location, frequency and/or length metric to assign a relevancy weight to the matching keyword. The location relevancy weight may comprise an indicator or multiplier to those keywords that appear near the beginning or top of the web page relevant to those keywords that appear near the end of bottom of the web page. The frequency relevancy weight may comprise an indicator or multiplier to those keywords that appear more times on the same page or content than other keywords. The length relevancy weight may comprise an indicator or multiplier to those keywords that have more words in the keywords than single keyword or keywords with less words.

Each type of metric relevancy weight may be weighted the same or differently. Each metric relevancy weight may have it owns multiplier or factor that scales the weight for the keyword up or down according to the relevancy. The keyword may be up weighted and/or down weighted one or more times by each of the metric relevancy weights. A keyword relevancy weight may be up weighted by one metric relevancy weight while downloaded by another relevancy weight. For example, a keyword may be repeated several times and be upweighted or have a high multiplier based on the frequency relevancy weight while only found and repeated near the end of the page for a down weighting or low multiplier from the location relevancy weight. In some embodiments, a keyword may get a low relevancy weighting from each of the metric relevancy weightings. In some embodiments, a keyword may get a high relevancy weighting from each of the metric relevancy weightings. In some embodiments, a keyword may get a combination of low and high relevancy weightings from different relevancy weightings.

Referring now to FIG. 5E, an embodiment of applying behavioral targeting is depicted. The ad server platform may identify, track and store formation about a user's behavior in a behavioral profile. The behavioral profile may comprise a profile for one user or a plurality of users. Each of the user's profile data may be identified, tracked and managed via unique user identifiers. In some embodiments, the ad server platform may track a predetermined number of search terms, such as 5, that the user last searched. In some embodiments, the ad server platform may track a predetermined number of search terms for each search engine, such as the Google search engine, Microsoft Bing search engine, Yahoo search or Ask search engine. In some embodiments, the ad server platform may track a predetermined number of search terms for each search engine across a combination of search engines. In some embodiments, the ad server platform tracks and stores those search terms for which the user clicked a search result. In some embodiments, the ad server platform tracks and stores those search terms for which the user clicked a search result. In some embodiments, the ad server platform tracks and stores those search terms for which the user clicked a search result and landed on a web page of a predetermined content provider or publisher.

Referring to FIG. 5F, a further embodiment of behavioral targeting is depicted. The ad server platform may track and store in the behavioral profile of a user a history of terms the user has seen over a predetermined time period. In some embodiments, the ad server platform tracks terms has a user has viewed on a web page. In some embodiments, the ad server platform tracks terms the user has selected from a search or interacted with during the user's viewing history. In some embodiments, the ad server platform tracks terms of one or more search results from which the user has clicked through. In some embodiments, the ad server platform tracks viewed terms over a predetermined time period. In some embodiments, the ad server platform tracks viewed terms over a start of a behavioral profile of the user to current time.

The ad server platform may use any of the search terms and/or viewed terms from the behavioral profile to make a change to the relevancy weightings of the matching keywords. Those matching keywords that the use has searched or viewed previously will have their relevancy weightings increased or upweighted via a behavioral targeting multiplier. In some embodiments, the ad server platform may use a combination of recently searched and viewed terms to apply a multiplier to each matching keyword. The ad server platform may use any temporal threshold to determine which search terms and/or viewed terms to use for determining a multiplier to the relevancy weightings of the matching keywords. The ad platform may apply higher behavioral targeting multipliers to those keywords that were recently viewed and/or recently search within a predetermined time history. The ad platform may apply no or lower behavioral targeting multipliers to those keywords that were not recently viewed and/or not recently search within the predetermined time history.

As a result of using behavioral profile data and behavioral targeting multipliers, as depicted in FIG. 5G, the ad server platform modifies the relevancy of the matching keywords from the site keyword list. The matching keywords are assigned a first relevancy weighting from the contextual targeting and are modified or changed to a second relevancy weighting from the behavioral targeting. In some embodiments, the ad server platform maintains both the contextual targeting relevancy weightings and the behavioral targeting relevancy weighting for each matching keyword. In some embodiments, the ad server platform maintains a single relevancy weighting keyword comprising the behavioral targeting multipliers (up weighting or down weighting) to the relevancy weighting applied by the contextual targeting.

Referring to FIG. 5H, an embodiment of campaign selection is depicted. In some embodiments, the results of contextual and/or behavioral targeting are used as input to the campaign selection engine. The ad server platform may use the relevancy weightings of the matching keywords from the site keyword list to determine which campaigns may be applicable to these matching keywords. Those campaigns not having keywords corresponding to any of the matching keywords may be dropped from consideration. In some embodiments, those campaigns not having a number of keywords corresponding to the matching keywords within a predetermined threshold may be dropped from consideration. In some embodiments, those campaigns having one or more keywords corresponding to a predetermined number of the top relevancy weighted keywords may be identified for consideration.

The ad server platform may order the list of campaigns under consideration using any type and form of algorithm. For example, the ad server platform may rank the campaigns based on having matching keywords with the highest combined relevancy weightings. the ad server platform may rank the campaigns based on having the highest number of matching keywords. The ad server platform may rank the campaigns based on a combination of the highest combined relevancy weightings and the highest number of matching keywords. The ad server platform may also order campaigns based on any type of priorities assigned to the campaigns. Some campaigns may have a high order of priority to deliver or serve than other campaigns.

The ad server platform may selected the campaigns to deliver from the ordered or ranked list of campaigns. The ad server platform may further restrict the selection based on any rules or policies of the ad server platform, the publisher or the campaign. For example, the campaign or publisher may have rules restricting the serving of a campaign directed to certain users, times of days, locations, browsers, or content. Once the selection of the one or more campaigns is made, the ad server platform generates a list of campaign keywords to hook and transmits these keywords to the agent of the client. The ad server platform may provide to the agent information on the publisher, campaign, tooltip/user interface overlay and/or augmented content with or corresponding to the keyword.

Referring now to FIGS. 5I, 5J and 5K, embodiments of systems and methods for delivering augmented content are depicted. FIG. 5I depicts an embodiment of a system for analyzing content of a page to determine keywords to augment for one or more campaigns. FIG. 5J depicts an embodiment of augmented content delivered to a web page of a client. FIG. 5k depicts embodiments of a method for analyzing and hooking keywords on a web page of a client.

In brief overview of FIG. 5I, an embodiment of a system for augmented keywords on a web page is depicted. A client 130 communicates with one or more content providers 120, such as publishers, via network(s) 140. The client 120 may include a browser that receives, loads and display content in the form of web page or pages 517 from the one or more contents providers. The client 130 also communicates with the augmentation server or ad server 110′. The page 517 being loaded or loaded by the browser comprises an agent 520. The agent 520 may communication page content 519 to the server 110, 110′ for analysis and received from the server 110, 110′ keywords, corresponding campaigns and/or augmented content. The keyword matcher 522 of server 110, 110′ may perform keyword matching, such as using site keyword list, on the page content 519 received from the agent 520. The keyword ranker 524 ranks the keywords to provide ranked keywords 528. The campaign selection engine 506 selects campaigns 526 based on the ranked keywords 528.

In further detail, the browser 515 may comprise any type and form of executable instructions for accessing information resources via a network 140 such as the Internet. The browser may include any user agent or software for retrieving, presenting, accessing and/or traversing information resources or documents on the world wide web or a network 140. The browser may include any functionality for loading, running, processing and/or displaying on a computer screen information written in HTML, XML, javascript, java, flash or any other language or a script used for web pages. Browser may include any functionality for displaying any type and form of content or features presented by web page or transmitted content provider 120. Browser may include any functionality for enabling a user to interact or interface with a web page. Browser may provide functionality for displaying advertisement information within a web page presented or displayed on a computer screen of client computer 130. In some embodiments, a browser is any version of Internet Explorer web browser manufactured by Microsoft Corp. In other embodiments, the browser is any version of the Chrome web browser manufactured by Google Inc. In other embodiments, the browser is any version of Firefox web browser distributed by the Mozilla Foundation. In further embodiments, the browser is any version of the Opera browser by Opera Software ASA.

The page 517 may include any type and form of content processable by any embodiment of the browser 515. The page may be stored on any number of servers, such as content providers 120 and may be accessed and/or loaded by any web browser, such as browser 515. The page may be a web page. The page be a document, The page may be a file. The page may any resource accessible via a network or a world wide web by a networked device, such as a client computer 130. The page may be identified by a URL. The page may include content from a URL. The page may include any type and form of executable instructions, such as scripts, AJAX. The page may include any type and form of graphics and/or text. The page may include any type and form of media, such as video or audio media. The page may include content having text, words, keywords and links or hyperlinks to other web pages or web sites.

Page 517 may include any document which may be accessed, loaded, viewed and/or edited by a browser 620 and displayed on a computer screen. Page 517 may include any content which may be presented via hypertext markup language, extensible markup language, java, javascript or any other language or script for preparing web pages. Web page may include any type and form of components for adding animation or interactivity to a web page, such as Adobe Flash by Adobe Systems Inc. The page may include functionality for displaying advertisements, such as advertisements from enterprises, government, companies and firms. A web page may include any number of ad spaces providing space or arrangement within web page for displaying advertisement.

The client, browser or page may include an agent 520. The agent may include any type and form of executable instructions executable by the browser and/or client. In some embodiments, the agent comprises a script, such as JavaScript or JSON (JavaScript Notation). In some embodiments, the agent may comprise any type and form of plug-in, add-on or component to or of browser 515. In some embodiments, the agent may comprise any type of application, program, service, process or task executable by the client.

The agent 520 may be included in the page 517 when transmitted by the content provider. In some embodiments, the page includes the agent in script form as part of the content of the page. In some embodiments, the page includes a URL to the script, such as URL pointing to or identifying a resource or script of the servers 110, 110′. In some embodiments, the agent is loaded by the browser. In some embodiments, the agent is executed by the browser upon retrieval and/or loading of the page 517. In some embodiments, the page includes instructions to the browser or client to obtain and load or install the agent.

The agent 520 may include any logic, function or operations to interface to or communicate with any portion of the augmentation server 110 or ad server platform 110. The agent may include any logic, function or operations to provide any of the services or functionality of in-text 510, interest ads 512 and/or related content 514. The agent may include any logic, function or operations to identify, collect and transmit content from the page to the server 110/110′. The agent may identify, collect and transmit any and/or all text in content of the page. The agent may identify, collect and transmit any and/or all text from any pages or URLs referred to by the page. The agent may transmit any embodiments of this page content 519 to the server 110, 110′.

The agent may comprise any logic, function or operations to receive keywords, campaigns and/or augmented content from the server 110, 110′. The agent may comprise any logic, function or operations to hook keywords identified in the page content. The agent may “hook” keywords by modifying the keyword in the page content to have an indicator, such as double underlined or an icon. Hooking a keyword refers to making a keyword on the page have a predetermined visual appearance to indicate that interactivity would or may occur by the user interacting with the keyword and instrumenting the page or keyword to perform the interactivity responsive to the user interaction. The indicator may provide a visual indication that the keyword in the text is linked or hyperlinked. In some embodiment, the agent may link or hyperlink the keyword. The agent may hook the keyword to include a function, script or executable instruction to take an action responsive to a mouse over, mouse click or other user interaction. The agent may hook the keyword to display a user interface overlay or tooltip such as depicted in FIG. 5J. The agent may hook the keyword to display a related advertisement or augmented content on the page as also depicted in FIG. 5J.

The keyword matcher 522 of the server 110, 110′ may comprise any type and form of executable instructions executable on a device. The keyword matcher may comprise any logic, function or operations to identify matches between one data set and another data set. In some embodiments, the keyword matcher may identify matches between keywords of campaigns with page content. In some embodiments, the keyword matcher may identify whole or complete matches. In some embodiments, the keyword matcher may identify partial or incomplete matches. In some embodiments, the keyword matcher may identify partial or incomplete matches within a predetermined threshold. In some embodiments, the keyword matcher may identify both complete and incomplete matches. The keyword matcher may perform any of the keyword operations described in connection with FIGS. 5A through 5F. The keyword matcher may be included as part of the context engine, interest engine or campaign selection engine of the ad server platform.

The keyword ranker 522 of the server 110, 110′ may comprise any type and form of executable instructions executable on a device. The keyword ranker may comprise any logic, function or operations to rank a set of data responsive to one or more criteria. The keyword ranker may comprise any logic, function or operations to rank keywords matched to page content. The keyword ranker may comprise any logic, function or operations to provide a weighting to a keyword based on any metrics of the keyword, such as location, frequency, and length. The keyword ranker may comprise any logic, function or operations to provide a weighting to a keyword based on relevancy to the site. The keyword ranker may comprise any logic, function or operations to provide a weighting to a keyword based on relevancy to a publisher or content provider. The keyword ranker may comprise any logic, function or operations to provide a weighting to a keyword based on relevancy to a campaign. The keyword ranker may comprise any logic, function or operations to provide a weighting to a keyword based on relevancy to a user or behavioral profile. The keyword ranker may be included as part of the context engine, interest engine or campaign selection engine of the ad server platform.

The keyword ranker may perform any of the keyword ranking and/or weighting operations described in connection with FIGS. 5A through 5F. An output or result of the keyword ranker may be ranked keywords 528. The ranked keywords may include any type of object, data structure or data stored in memory or to storage. The ranked keywords may include contextually targeted ranked keywords as described in connection with FIGS. 5A through 5F. The ranked keywords may include behavioral targeting ranked keywords as described in connection with FIGS. 5A through 5F. The ranked keywords may include any combination of contextually targeted ranked keywords and behavioral targeting ranked keywords. The ranked keywords may be site specific. The ranked keywords may be campaign specific. The ranked keywords may be publisher specific. The ranked keywords may be based on any combination of site, campaign and/or publisher.

The campaign selection engine 506 may interface or communicate with any of the keyword matcher, the keyword ranker and/or ranked keywords. The campaign selection engine 506 may access, read or process campaigns 526. The campaigns 526 may be stored in any type and form of database or file system. The campaigns 526 may include information identifying keywords for the campaigns and augmented content to deliver for those keywords. The campaigns 526 may include any type and form of content, URLS, scripts, video, audio, advertisements, media, text, graphics, data, information etc. to provide as augmented content with the keywords. The campaigns 526 may include any type and form of URLs, advertisements, media, text, graphics, etc. to provide as augmented content with the keywords. The campaigns may identify or provide any desired user interface overlay/tooltip or content therein. The campaigns may be organized by publisher. Each publisher may have a plurality of campaigns.

The campaign selection engine selects the campaign to deliver with the page based on analysis of the page content from the keyword matcher, keyword ranker and ranked keywords. The campaign selection engine may comprise any type and form of logic, functions or operations to identify and select one or more campaigns from a list of contender or candidate campaigns based on any criteria or algorithm. The campaign selection engine may select those campaigns that best match or correspond to the top ranked keywords. The campaign selection engine may select those campaigns that match or correspond to a predetermined number of ranked keywords. The campaign selection engine may select those campaigns that match or correspond to a predetermined set of ranked keywords. The campaign selection engine may select those campaigns that match or correspond to the ranked keywords in accordance with a priority assigned to the campaigns or publisher. The campaign selection engine may exclude or include campaigns based on the logic or criteria of any rules or filters.

Responsive to the campaign selection engine, the server 110, 110′ may transmit to the agent identification of one or more keywords to augment on the page and corresponding campaigns for those keywords (see 530). The server may transmit to the agent any script, data or information to provide or facilitate hooking of the keywords on the page and displaying the campaign responsive to user interaction with the keyword. The server may transmit to the agent the indicator, or identification of the indicator) to use for a hooked keyword. The server may transmit to the agent the type and form of user interface overlay to display when a user mouse over or mouse click occurs for the keyword. The server may transmit to the agent a reference to or identification of any of augmented content to display when a mouse over or mouse click occurs for the keyword. The server may transmit to the agent the augmented content, such as the advertisement, to display when a mouse over or mouse click occurs for the keyword.

The agent may receive the information 530 from the server and modify the page or content of the agent to perform the hooking of the keywords, to instrument the hooked keywords, and/or deliver the campaign responsive to the keyword. The agent may perform any of the agent's logic, functions or operations while the web page is being loaded. The agent may perform any of the agent's logic, functions or operations while the user views or browsers the web page. The agent may perform any of the agent's logic, functions or operations in the background to the user viewing or browsing the page.

Referring now to FIG. 5J, embodiments of augmented content delivered with a corresponding keyword is depicted. In brief overview, the page 517 may include an augmented keyword in the text of the content (e.g., see double underlined “Augmented Keyword” next to “in text of content”). When a user interacts with the augmented keywords, a user interface overlay 550, also referred to as tooltip, may be displayed. This user interface overlay may deliver or provide the campaign corresponding to the keyword. Responsive to user interaction with the keyword, the agent may display related advertisements 554′, such as via a banner ad, or augmented content 556′. The related advertisements 554′ and/or augmented content 556′ may be displayed in connection with the tooltip, without the tooltip or instead of the tooltip.

Any of the content on page 517 may include any embodiments of the advertisements and/or augmented contented provided and discussed above in connections with FIGS. 1 through 4E. The tooltip may be part of a multi-layered augmentation content or advertisement unit. The tooltip may provide any one or more URLs to access related websites.

The user interface overlay 550 referred to as a tooltip may include any type and form of web beacon 545. In some embodiments, the tooltip 550 may include a plurality of web beacons. The beacon may be used for tracking a user's usage and/or interactions with the tooltip. The beacon may identify or track a length of time of any user interaction with the tooltip and/or augments keyword or inline text. The beacon may identify a URL or tracking system to register or send communications regarding the user interaction. In some embodiments, a web beacon may be designed and constructed for a predetermined tracking system.

A web beacon may be an object that is embedded in the tooltip that is not visible to the user. Sometimes beacons are referred to as web beacons, web bugs, tracking bugs, pixel tags or clear gifs. Web beacons may be used to understand the behavior of users who frequent designated web pages. A web beacon permits a third party to track and/or collect various types of information. For instance, a web beacon may be used to determine who is reading a webpage, when the webpage is read, how long the page was viewed, the type of browser used to view the webpage, information from previously set cookies, and from what computer the webpage is accessed.

The tooltip may be incorporated, integrated or presented with any one or more of related advertisements 554, related video 558 and/or real time statistics 562. The tooltip 550 may include an URL 560 to any web page or resource, such as additional content, search results, or media. Although the tooltip 550 is illustrated each with a related advertisement, related video and related statistics, the tooltip 550 may be presented with one of these related content or a plurality of these related contents. Although this related content is illustrated in a location, size and position in relation to the tooltip, the related advertisements, related video, and/or real time statistics may be arranged, organized or presented in any manner.

The tooltip may also include one or URLs 560, such as a hypertexted URL or link to any other page or content. In some embodiments, the hypertexted link 560 comprises a URL of a landing page of a web site. In some embodiments, the hypertexted link 560 comprises a URL of a web page providing search results directly from the search engine. In another embodiment, the hypertexted link 560 provides a link to a recommend or most relevant search result. In other embodiments, the hypertexted link 560 provides a link to run the search query on a second search engine. The hypertexted link 560 may bring the user to a landing page of the search results of the second search engine.

The related advertisements 554 may include any type and form of advertisement related to the augmented content or inline text or otherwise related to the keyword. In some embodiments, the related advertisements are advertisements provided as described in connection with any of the embodiments of the FIGS. 1A-4E. In some embodiments, the related advertisements are advertisements provided by a search engine, such as in relation to and based on the search query. In other embodiments, the related advertisements are provided by any type and form of ad network via the server 110, 110′ and/or search engine.

The related video 558 may include any type and form of video media related to the augmented content or inline text or otherwise related to the keyword. In some embodiments, the related videos are advertisements provided as augmented content as described in connection with any of the embodiments of the FIGS. 1A-4E. In some embodiments, the related videos are videos provided by a search engine, such as in relation to and based on a search query. In other embodiments, the related videos are provided by any type and form of video service, such as YouTube.com or iTunes.com. In another embodiment, the related videos are videos available to the user via a user accessible storage or video management system.

The real time statistics 562 may include any type and form of statistics related to the augmented content or inline text or otherwise related to the keyword. In some embodiments, the real time statistics 562 may be any statistics related to the person or entity of the search. For example, if the augmented keyword is a sports team, the real time statistics may include current or recent game scores and/or standings of the team. In another example, if the augmented keyword is related to the weather, the real time statistics may include a current weather forecast. In one example, if the augmented keyword is related to a musician, the real time statistics may include statistics on music downloads, album sales and top music chart location.

Referring now to FIG. 5K, embodiments of a method for augmented content of a keyword of a web page being loaded into a browser is depicted. In brief overview, at step 580, an agent of the browser to server 110, 110′ upon or while loading a web page. At step 582, the server analyzes the page data and reduced the page data set. At step 584, the server performs content filtering on page and keywords to match to corresponding campaigns. At step 586, the server performs ranking of keywords. At step 588, the server matches the ranked keywords to keywords of each campaign. At step 590, the server selects top matching keywords and their campaigns. At step 592, the server sends to the agent the selected keywords and their campaigns and may provide the agent tooltips and/or augmented content. At step 594, the agent hooks the keywords identified by the server. At step 596, the agent detects user interaction such as mouse over or clock of keywords and displays augmented content, such as a tooltip.

In further details, at step 580, the agent may be executed by the browser upon or while loading the web page. The browser may retrieve the agent via a URL identified by the page. In some embodiments, the page transmitted by the server includes the agent,. The agent may comprise script places or arranged at or near the top page to be executed by the browser. In some embodiments, the agent may be triggered by any load events or APIs of the browser. The agent may be executed prior to content of the web page being loaded or displayed. The agent may be executed prior to the retrieval of any URLS of the page. The agent may be executed prior to completion of loading of the web page by the browser.

The agent may identify, gather and aggregate data from the page. The agent many identify all text portions of the web page. The agent many identify those elements of the page that contain text. The agent may identify text from a predetermined set of elements of the page. The agent may identify text from HTML, XML or other page languages. The agent may identify text from the body of an HTTP portion of the page. The agent may perform text recognition on any portion of the page or any element of the page. The agent may identify text from any URLS or other content referred to or loaded by the page. The agent may identify any other date of the page, including headers. For example, the agent may identify the browser type, the user, location, IP addresses from the content of the page or from any of the network packets used for communicating the page. In some embodiments, the agents performs analysis and identified metrics for the page date, such as text location, frequency, length and repeatability.

The agent may gather the identified page data, text or otherwise, and/or any page metrics and transmits the page data and/or page metrics to the server 110, 110′. In some embodiments, the agent transmits the page data together in one transaction with the server. In some embodiments, the agent transmits portions of page data in a series of transactions with the server. In some embodiments, the agent transmits the page data using any type and form of protocol. In some embodiments, the agent transmits the page data as a background process to the browser loading the page or the user browsing the page. In some embodiments, the agent transmits the page data while the browser is loading the page.

At step 582, the server analyzes the page data and reduces the page data to a working set of page data to continue analysis. The server may remove a predetermined set of commons words, such as a, and, the, from the page data. In some embodiments, the server may filer a predetermined set of words, phrases, terms or characters according to any filters, rules or policies. In some embodiments, the server may identify and correct any typos or other inadvertences with the page data. In some embodiments, the server may perform any type and form of metrics on the page data. In some embodiments, the server may identify location, frequency, repeatability of text on the page. In some embodiments, the server may identify location, frequency, repeatability of text on the page data relative to other text on the page.

At step 584, the server analyzes the text from the working set of page data to determine if there is any type and form of matching to any campaigns. In some embodiments, the server performs any type and form of semantic matching to match keywords on the page semantically to concepts, meanings, categories, subject matter and/or keywords of campaigns. In some embodiments, the server performs a phonetic match between keywords on the page to keywords of campaigns. In some embodiments, the server performs a spelling match between keywords on the page to keywords of campaigns. In some embodiments, the server performs content filtering on text, words, and portions of content around the keywords on the page to determine a context for the keywords and match that context to campaigns. In some embodiments, the server performs content filtering on the page data to determine a category, a sub-category, a topic, subject matter or other information indicator and matches the same to any one or more campaigns.

In some embodiments, the server may generate a set of keyword from campaigns targeted towards the site of the page or publisher of the page. The server may generate a site keyword list. The keyword matcher of the server may match keywords from a keyword list, such as the site keyword list, against text of the page data to identify keywords in the page data. In some embodiments, the keyword matcher identifies multiple word phrase matches. In some embodiments, the keyword matcher identifies partial word phrases. In some embodiments, the keyword matcher identifies a number of times or the frequency for which a keyword is found in the page data. In some embodiments, the keyword matcher identifies the location of the keyword in the page data, and in further embodiments, relative to other keywords or boundaries of the page, such as top or bottom.

At step 586, the server performs any type and form ranking of keywords of the page data identified by the keyword matcher. The keyword ranker may rank all of the matching keywords. The keyword rank may rank a predetermined number of keywords. The keyword ranker may rank the keywords according to any one or more metrics. The keyword ranker may rank the keywords according to any one or more criteria. The keyword ranker may rank each keywords by applying a weight to a value assigned to the keyword. The keyword ranker may provide any multipliers to a valued or weighted value of the keyword to increase or decrease the ranking of the keyword. The keyword ranker may rank the keywords on any type and form of scale, which may be absolute or relative.

At step 588, the server matches the ranked keywords to keywords of one or more campaigns. The keyword matcher, ranker or campaign selection engine may compare the list of ranked keywords, or any portions thereof, to a list of keywords of one or more campaigns. In some embodiments, the server identifies those campaigns that are contenders to be a selected for the campaign for this page. In some embodiments, the server identifies those campaigns associated with or assigned to be a campaign targeted to site or publisher of the page. The server may match the ranked keywords against the identified campaigns. In some embodiments, the server may match the ranked keywords against all campaigns. In some embodiments, the server may change the ranking of the keywords based on results of matching the keywords from the campaigns.

At step 590, the campaign selection engine selects a predetermined number of matching keywords and their campaigns. In some embodiments, the campaign selection engine selects a predetermined number of top matching keywords and their campaigns. In some embodiments, the campaign selection engine selects a number of top matching keywords and their campaigns corresponding to a number of matching keywords on the page. For example, if there are five unique keywords on the page and each identified by a campaign, the server may select five campaigns. In some embodiments, the campaign selection engine may select one campaign for a plurality of corresponding matching keywords on the page.

In some embodiments, the campaign selection engine may filter out campaigns based on any type and form of filter rules. The campaign selection engine may rank campaigns according to any type and form of ranking. For example, the campaign selection engine may prioritize campaigns according to clients, volume, importance, spend, budget, historical campaign performance or any other desired criteria. The campaign selection engine may compare the ranked keywords to the ranked campaigns. The campaign selection engine may select any of the higher or highest ranked campaigns matching any of the higher or highest ranked keywords.

At step 592, the server sends to the agent the selected keywords and their campaigns. Responsive to the campaign selection engine, the server may send to the agent the list of keywords to augment or hook and their corresponding campaigns. In some embodiments, the server sends a predetermined number of additional keywords to augment or hook in case the agent cannot hook or augment any one or more keywords in the list of keywords. In some embodiments, the server sends an ordered list of keywords. The ordered list of keywords may identify a priority of augmentation or hooking to the agent.

The server may send any type and form of information to the agent on how to augment or hook a keyword, what type of augmentation to use and identifying the form and content of the augmentation. In some embodiments, the server sends to the agent publisher and campaign identifiers for the agent to obtain or identify the appropriate campaign for a keyword. In some embodiments, the server sends the agent an indication of the visual indicator to use for the hooked keyword (e.g., double underlined). In some embodiments, the server sends the agent the executable instructions by which the keyword is hooked or for replacing the text of the keyword with a hooked keyword.

In some embodiments, the server sends instructions for content, construction and/or display of the tooltip. In some embodiments, the server sends a set of executable instructions providing the tooltip and/or any portion thereof. In some embodiments, the server sends a set of executable instructions providing the augmented content and/or any portion thereof. In some embodiments, the server sends a set of executable instructions providing any embodiments of the augmented content, advertisements and/or tooltip of FIG. 5I. In some embodiments, the server sends content for the tooltip to provide the campaign assigned to the keyword. In some embodiments, the server sends one or more URLs referencing a campaign to be delivered via a web-site. For example, in some embodiments, the server sends one or more URLS to advertisements to be delivered for the campaign. In some embodiments, the server sends one or more scripts to agent to provide any of the above embodiments.

At step 594, the agent hooks the identified keywords on the page The agent may replace each keyword in the identified list of keywords from the server with instructions or code to hook the keyword. The agent may have hyperlink or link the keyword to a set of code or executable instructions to display the tooltip, augmented content or any embodiments of FIG. 5J. The agent may use modify the keyword to provide any type and form of visual indicator (e.g., double underlined or icon) to indicate the keyword is user interactive, hyperlinked or linked or otherwise hooked. The agent may modify the page to change the text to a liked or hooked text and to link or associated any forms of augmented content of FIG. 5J to be displayed or provided via user interaction with the hooked text. The agent may modify the page or instrument the keyword to detect when a user interacts with the keyword in a certain way. The agent may include one or more event based functions that are trigged responsive to predetermined user interactions. For example, the agent may modify the page or instrument the keyword to detect when a user mouses over the keyword, clicks on the keyword, right clicks on the keyword or left clicks on the keyword or otherwise selects any predetermined set of keystrokes or sequence of keystrokes.

At step 596, the agent detects user interaction such as mouse over or click of a keyword on the page and displays augmented content, such as a tooltip. The agent may detect when a mouse is over the keyword at any time. The agent may detect when a user has the cursor over the keyword. The agent may detect when a user has put focus on the keyword. The agent may detect when a mouse is over the keyword for a predetermined period of time. The agent may detect when a user highlights or selects a keyword. The agent may detect when the user left or right clicks on the keyword. The agent may detect when a user double clicks the keyword. The agent may detect when a user has put focus on the keyword and hit entered. The agent may detect any set of keystrokes with respect to the keyword.

Responsive to the detection, the agent may display augmented content, for example, any of the forms depicted in FIG. 5I. In some embodiments, responsive to detecting a mouse over of the keyword, the agent displays a tooltip delivering a campaign assigned to the keyword. In some embodiments, responsive to detecting a click on the keyword, the agent displays a tooltip delivering a campaign assigned to the keyword. Responsive to detection of the predetermined user interaction, the agent may display augmented content of any form, such as related videos, in predetermined areas or space on the page. Responsive to detection of the predetermined user interaction, the agent may display advertisements of any form, in predetermined areas or space on the page.

In some embodiments, the tooltip may remain displayed until the mouse is moved off of the keyword. In some embodiments, the tooltip may remain displayed until the mouse is moved off of the keyword for a predetermined time. In some embodiments, the tooltip may remain displayed until the mouse is moved off of the keyword until the user closes or exists the tooltip. In some embodiments, if the user clicks on the keyword after the mouse over, the tooltip remains displayed until the user closers or exits the tooltip. In some embodiments, any augmented content may change as the user moves the focus or mouse over to another keyword. For example, moving the mouse to a second keyword may cause a different advertisement to appear in a banner ad or may cause a new tooltip to be displayed or content of the current displayed tooltip to change.

The agent and may perform all or any of the steps of the method of FIG. 5K in real-time upon receipt and/or loading of the page. For example, the agent and the server may be designed and constructed to perform embodiments of steps 580 through 594 within a predetermined time while the page is being loaded by the browser. In some embodiments, the agent and the server may perform embodiments of steps 580 through 594 in milliseconds, for example within in 100, 200, 300, 400, 500, 600, 700, 800 or 900 milliseconds or within 10, 20, 30, 40, 50, 60, 70, 80 or 90 milliseconds, or within 1, 2, 3, 4, 5, 6, 7, 8 or 9 milliseconds or 0.1, 0.2, 0.3, 0.4, 0.5, 0.6, 0.7, 0.8 or 0.9 milliseconds. The agent and the server may be designed and constructed to perform embodiments of steps 580 through 594 while the page is loading and before the page is completely loaded. The agent and the server may be designed and constructed to perform embodiments of steps 580 through 594 in the background while the pages is being loaded and/or the user is browsing the loaded page.

D. Systems and Methods of Using a Cache Comprising a Hierarchy of a Plurality of Cache Layers of Different Types

The amount of online activity required for a certain task (e.g., online information gathering) may vary. The overall time required to accomplish a certain task online may even be tedious in certain cases. In some implementations, the time to process each activity, such as a click on a hyperlink, may depend on the backend platform services that process the click. Such processing time may introduce a delay or latency to each activity. For example, a platform service (e.g., an augmentation server of an in-text advertising service) may collect and/or analyze the context of a respective webpage, website, user preference and/or other data to process the click. The platform service may perform this in real-time, e.g., before or interleaved with the loading or rendering of requested information to the user. The platform service may collect, store and/or process some of these information, for example, to enhance user experience (e.g., cater to particular preferences), improve web services (e.g., provide targeted advertising) and/or compile activity statistics. In view of the amount of online activity and the latency associated with each activity, conventional system are not always optimized towards enhancing users' online experience. Even when a platform service for processing and/or tracking online activities may not significantly degrade a user's online experience, it is beneficial to improve the processing efficiency and management effectiveness of these platform services.

One beneficial aspect of platform services is cache management of data handled by the platform services. A platform service may cache any type or form of data received and/or generated by the platform service. For example and in one embodiment, a platform service for online advertising may store data associated with clicks (e.g., mouse clicks, mouse-overs, and other user actions), ad views, encryption or license keys, and/or keyfiles. When processing an online activity (e.g., a click on a hyperlink) or an administrative task (e.g., compiling, generating and/or validating statistics on online activity), a platform service may use a structured cache system to store and manage the associated data. A cache manager may manage a hierarchy or collection of cache partitions, levels, segments or layers (hereafter sometimes generally referred to as “layers”). At least some of the layers may be of different types, have different properties and may store data in different arrangements. The different properties and/or different storage arrangements between the cache layers may allow data to be stored, updated, managed, shared, retrieved or otherwise used more efficiently and/or flexibly by the platform service. For example, memory space may be better utilized while providing quicker access to different types of stored data. Various properties may be incorporated or modified by adding cache layers.

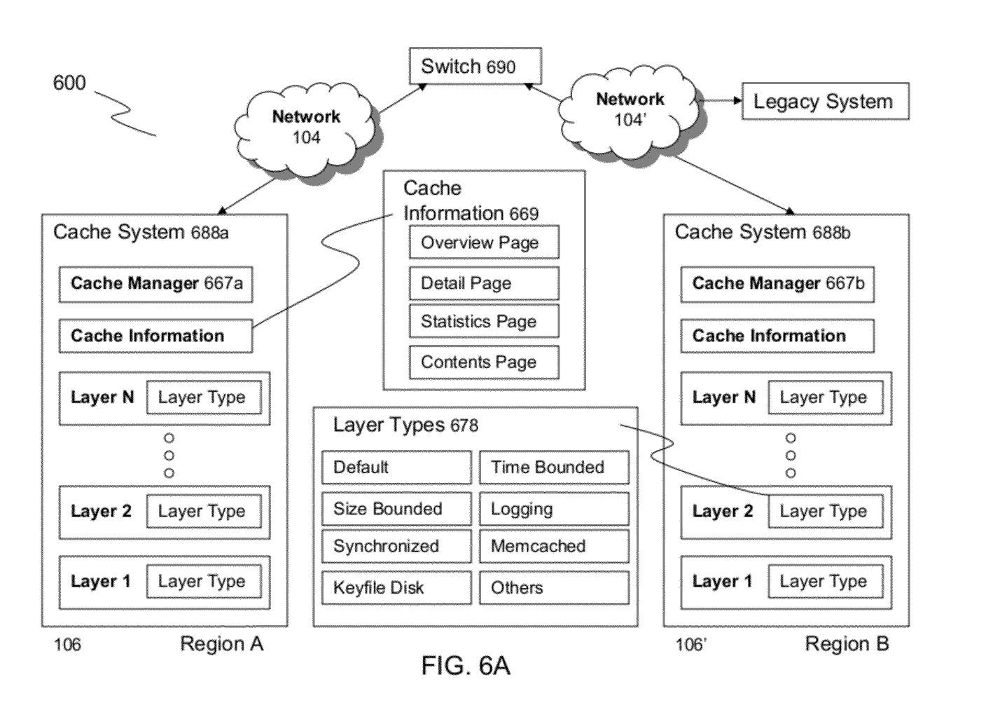

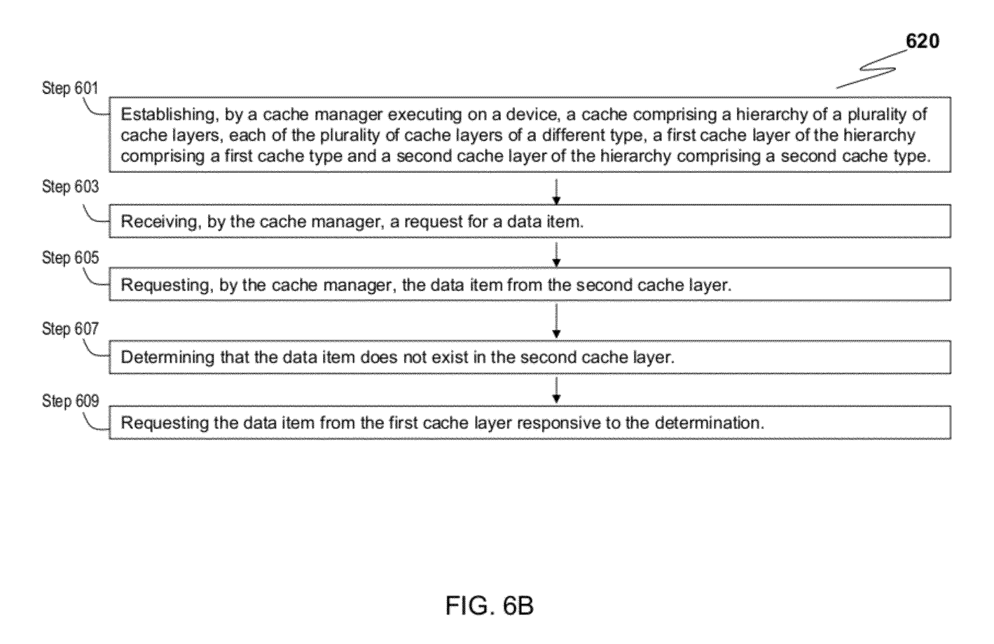

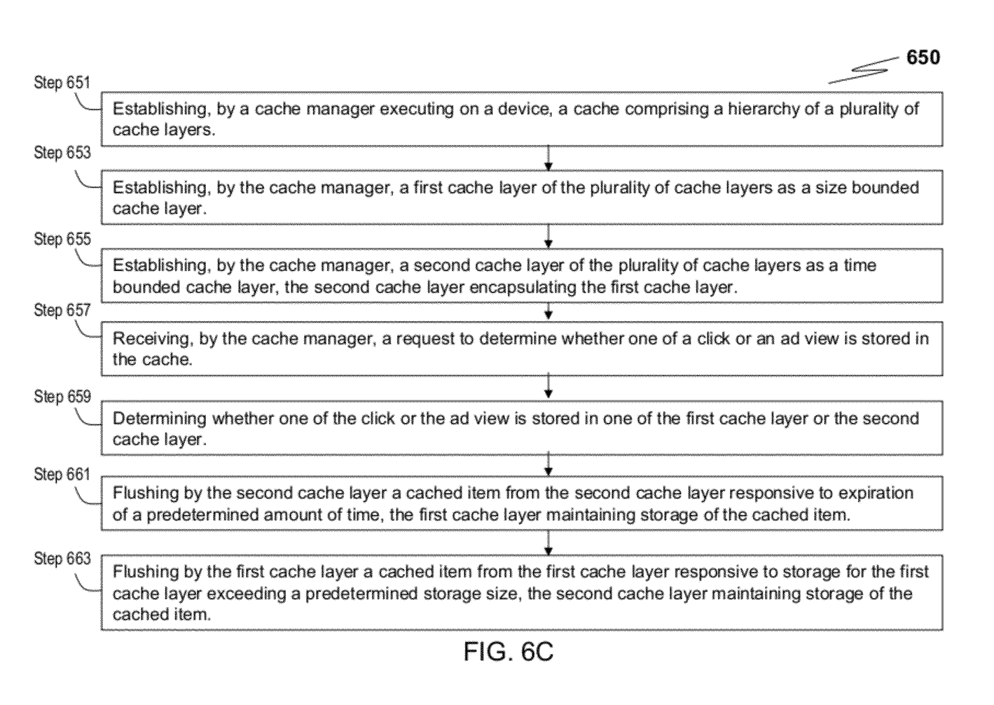

Referring to FIG. 6A, one embodiment of a platform 600 for managing one or more cache systems each comprising a hierarchy of a plurality of cache layers of different types, is depicted. In brief overview, the platform includes a switch 690 for directing communications such as queries and requests between a plurality of cache systems. Each cache system may include a cache manager 667 managing one or more cache layers. In some embodiments, each cache system may be assigned to a region.

A region may be geographical in nature (e.g., Eastern U.S., New England, Maryland, Atlanta, etc) and/or network-based (e.g., incorporating one or more local area networks (LANs), an/or a set of network domains, base IP addresses, and/or associated with an network gateway or switch). In some embodiments, a region identifier may identify a particular cache system from another cache system, e.g., even when both cache systems reside at the same location and/or within the same network. In one of these embodiments, a region identifier may identify a server 106 hosting a cache system 688a, and may distinguish the server 106 from another server 106′ hosting another cache system 688b. In certain embodiments, a region identifier identifies a portion, image or instance of a distributed cache platform, system or layer, e.g., a memcached system. A regional cache instance of memcached may be used by some or all cache systems. Some embodiments and features of a memcached system may, for example, be found at memcached.org.

The platform 600 may include a switch 690. The switch 690 may include any hardware or combination of hardware and software. The switch 690 may include any module, script, program, agent, state machine, component or set of executable instructions executing in the hardware components of the switch 690. The switch 690 may store and/or execute any software that may be proprietary, custom, open-source, standard and/or commercially-available. The switch 690 may be designed, constructed and/or configured to provide access to one or more services, objects, networks and/or devices. In some embodiments, the switch 690 is designed, constructed and/or configured to manage and/or provide access to a plurality of cache systems. The plurality of cache systems may include a distributed set of cache modules. The plurality of cache systems may include one or more redundant, back-up, parallel-processing and/or inactive cache systems or modules. In certain embodiments, the plurality of cache systems may include one or more legacy cache systems.

In some embodiments, the switch 690 may include one or more features of a computing device, such as embodiments of computing devices 100, servers 110 and/or platform services described above in connection with FIGS. 1A-C, 2, 5A and 5I. In certain embodiments, switch 690 may be a Java Management Extension (JMX) switch, or may include features of a JMX switch. A platform service, such as the In-text advertising platform (IntelliTXT) may include such a switch 690. In certain embodiments, a server 106 such as the augmentation server 110 may host at least one switch 690 or a portion of a switch 690. The switch 690 may redirect communications, queries and/or requests (e.g., for online activity report, click validation, ad view, etc) to one or more cache systems 688 and/or other network services. In some embodiments, the switch 690 may perform load-balancing functions and/or power-saving distributive functions. For example and in one embodiment, the switch 690 may direct cache-related communications to one or more cache systems while maximizing the number of other cache systems in low-power or inactive mode.

In some embodiments, the switch 690 performs certain functions of a cache manager 677. For example, the switch 690 may manage and/or coordinate cache operations at a higher level relative to cache managers 667, for example at a global level. In one of these embodiments, a switch 690 may manage and/or coordinate cache operations across a distributed cache system and/or a plurality of cache systems. The switch 690 may coordinate or manage cache operations via one or more cache managers 667. In certain embodiments, the switch 690 may direct, coordinate and/or manage cache-related communications across one or more networks 104, 104′, such as over a LAN, WAN or the internet. Communications between the switch 690 and a cache system 688 may be secured, e.g., via encrypted connection. For example and in one embodiment, the communications may be transmitted over a secure socket level virtual private network (SSL VPN) connection.

The platform 600 may include one or more cache systems 688. A cache system 688 may sometimes be referred to generally as a cache (e.g., click cache). The one or more cache systems 688 may be hosted in one or more servers 106. Each of these cache systems may provide any type or form of single-cache or multi-cache structure hosted in one or more memory modules. Each memory module may include features from embodiments of memory units 122, 128, 140 and/or databases 39 described above in connection with FIGS. 1B-C and 2. The cache structure of the cache system 688 may include one or more separate physical and/or logical partitions, levels, segments or layers (hereafter sometimes generally referred to as “layers”). The cache system may configure, structure and/or establish the one or more cache layers via a cache manager 667. Each cache layer may be configured, structured and/or established independently or in relation to another layer. In some embodiments, the cache layers may operate in a coordinated or related fashion, sometimes referred to as layered caching, via the cache manager 667.

A cache layer may be identified to be of a specific layer type 678, such as default, size bounded, time bounded, synchronized, logging and memcached, although not limited to these types. Each type of cache layer may have a different cache structure for arranging, prioritizing and/or storing data items. For example, one type of cache layer may arrange or manage data items by a date of the data item. Another type of cache layer may arrange or manage data items by size, type, or other property of the data item. One type of cache layer may store a data item in larger memory chunks, resulting in more memory fragmentation. Various types of cache layers may store or map a data item at a byte, packet or file level. The different arrangements and data structures may allow a type of cache layer to retrieve, store, map, query, process or otherwise manage a data item more efficiently than another cache layer type. A cache layer may sometimes be referred to generally as a cache. In some cases, the memory structure in a cache layer for storing, maintaining, retrieving and/or managing data items may sometimes be referred to generally as a cache.

The cache manager 667 and/or the respective cache layer may assign a property to a data item in one layer. The same data item may be assigned a different property under another layer of a different layer type. For example and in one embodiment, the TTL value assigned to the same data item may be different under two different layer types. One layer type may retain a data item for a longer period than another, due to a longer TTL for example. As another example, one layer type may retain a data item for a longer period than another, e.g., due to a different cache flush interval.

In certain embodiments, one layer may be encapsulated or wrapped by another layer. The encapsulating layer is sometimes referred or identified as a decorator. A cache layer can be wrapped or encapsulated by one or more decorators. Each decorator wrapped over a cache layer may enhance the functionality of the cache layer, such as by modifying layer properties. The platform may describe the type of a cache system in various ways. In one embodiment, the platform describes the type of a cache system in one of two ways: by a simple layer type and a full layer type. By way of illustration and in one embodiment, a cache system 688 (e.g., click, ad view or key cache system) may contain a size bounded cache layer. This may be wrapped by a time bounded cache, a synchronized layer and a logging component. In this embodiment, the simple layer type of the cache or cache system is: size bounded. The full layer type may be represented as: sizeBounded[timeBounded] [synchronized], where each of the decorators are listed in the full layer type and enclosed in square brackets (“[” and “]”). In some embodiments, a logging layer operates somewhat differently as a wrapper. Although a logging layer may wrap a cache layer, the logging layer's presence may not be indicated in the full layer type of the cache layer.

In some embodiments, a data item stored to one layer may be inspected by an encapsulating layer. In one embodiment, the data item may be copied and/or stored to the encapsulating layer. In another embodiment, the data item is mapped or linked from the first layer to the encapsulating layer. In some embodiments, the data item may be stored in both layers. In certain embodiments, the data item is removed from a first layer when it is stored in a second layer. In one embodiment, the data item may removed from the first layer, responsive to removing the data item in a second layer. In another embodiments, the data item may maintained in a layer while removed from another layer.

In some embodiments, encapsulation of a layer refers to duplicated storage between the encapsulating and the encapsulated layer. In other embodiments, encapsulation of a layer refers to mapping of a data item from the encapsulated layer to the encapsulating layer. Some of the following processes that relate to encapsulation may be performed by a cache manager and/or the respective cache layer. For example, in certain embodiments, the data item may be reformatted and/or stored in a different data structure between the two layers. The data item may be mapped, arranged and/or prioritized according to a different order between the two layers. The different arrangement and/or priority may be attributed to a different cache structure between the two layers. These different structures may be logically mapped between the two layers.

An encapsulating layer may lend at least some of its functionalities and/or properties to an encapsulated layer. For example and in one embodiment, the TTL specified by the encapsulating layer for a data item may override or replace the TTL specified by the encapsulated layer. Certain types of layers, e.g., synchronized, keyfile disk, time bounded, memcached and logging cache layers, may be used as encapsulation layers or decorators. Other types of layers, e.g., default, memcached and size bounded cache layers may serve as encapsulated layers. The latter types may in some embodiments be a top layer, e.g., when the cache is single-layered. By way of illustration and not intended to be limiting in any way, a cache system 688 may support one or more of the following types of cache layers:

### Default Cache Layer

In some embodiments, a layered cache system 688 includes a default cache layer. The default cache layer is an in memory cache implementation. Data items may remain in this cache layer until explicitly deleted. The default cache layer may have a layer type of “inMemory”. Accordingly, the default cache layer may display or indicate a layer type of “inMemory” on the information page for the platform's cache systems. In some embodiments, the default cache layer is primarily used for testing purposes. The default cache layer may be configured via program code in a script or entered by a user via a user interface.

In some embodiments, a layered cache system 688 includes a default cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a default cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Size Bounded Cache Layer

In some embodiments, a layered cache system 688 includes a size bounded cache layer. In one embodiment, a size bounded cache layer is a simple in-memory layer. The size bounded cache layer may use a least recently used (LRU) algorithm to remove or delete data items when the cache layer reaches capacity. In other embodiments, the size bounded cache layer may use a different algorithm or additional algorithms to remove data items, e.g., least-used or nearest to expiration based on TTL. In some embodiments, the size bounded cache layer has a layer type of “sizeBounded”. The size bounded cache layer may use the BoundedLocalCacheLayerConfigurator command for configuration of the cache layer. In some embodiments, the BoundedLocalCacheLayerConfigurator command supports the following configuration option:

BoundedLocalCacheLayerConfigurator.cacheName.maxSize

This configuration option may take a numerical value, such as an integer value, that sets the maximum size (“maxSize” setting) for this cache layer. The maxSize setting can be configured for any units, such as in kilobyte (KB) or megabyte (MB). In some embodiments, the maximum size may be configured in terms of the number of data items the cache layer can hold. In some embodiments, an attempt to store a new value in the cache layer after it has reached maxSize may result in the removal of an element (e.g., least recently used) of the cache layer. This maxSize value may be altered during a configuration stage and/or at runtime. Because the cache may be locked at the reduced size in some embodiments, it may be advisable to exercise care when reducing the cache size. For example, the cache manage may not be able to remove data items until the cache layer reaches the new maximum size. In certain embodiments, increasing the size of the cache dynamically incurs no cost. In one embodiment, the default value for maxSize is 10,000 (e.g., data items), although other values may be used. The platform may require a default value to be greater than zero.

In some embodiments, a layered cache system 688 includes a size bounded cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a size bounded cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Time Bounded Cache Layer

In some embodiments, a layered cache system 688 includes a time bounded cache layer. A time bounded cache layer is a wrapper around another cache layer which may allow the encapsulated cache layer to become time bounded. Data items may be ejected or removed from the cache layer if the data items have not been read or updated within their assigned update time(s), for example. Calling a “put”, “contains” or “get” operation on a data item may reset the data item's update time. In addition, each item may have a TTL. If an item reaches its TTL the data item may be removed from the cache layer or cache. A data item may be removed from the cache layer or cache responsive to its TTL regardless of whether it has reached its update time. The time bounded cache layer performs checks on at least some of its data items each time the cache layer is called. The time bounded cache layer can optionally have a cleanup thread that periodically removes stale (e.g., unused) data items.

In some embodiments, a time bounded cache layer wraps another layer. The time bounded cache layer may add the decorator [timeBounded] to the full cache type descriptor. The time bounded cache layer uses a TimeBoundedLocalCacheLayerConfigurator command for configuration purposes. In one embodiment, this command has three configuration options listed below. In some embodiments, the size of a time bounded cache layer may report the number of data items currently in the layer. The time bounded cache layer may not take into account whether a data item has expired or not when reporting the number of data items currently in the layer. In some embodiments, the cache manager 667 may run a cleanup thread to, for example, periodically remove items that have expired. This may result in a reported cache size that shrink over time as data items are removed.

TimeBoundedLocalCacheLayerConfigurator.cacheName.ttl

This configuration option may be used to set a TTL for one or more data items in the time bounded cache layer. The TTL may be set in any unit, such as in seconds, hours, days, or any combination thereof. In some embodiments, this configuration option takes a long value that sets the TTL in milliseconds for items in the layer. In one embodiments, the TTL must be positive, i.e., greater than 0. Data items may be marked for removal or ejection from the cache layer when each respective data item's age exceeds the TTL. The TTL may be reset or altered at runtime and/or during a configuration stage. Reseting or altering the TTL may affect all items in the cache layer. In certain embodiments, there may be no significant costs associated with altering the TTL. In one embodiment, the default TTL value is 1 day (86,400,000 ms), although other values may be used. In some embodiments, setting a small value for the TTL may result in a correspondingly high cache layer throughput. This may have an impact on efficiency of the cache layer. In some embodiments, setting a TTL of less than an assigned timeout value may effectively disable the timeout setting. However, in some of these embodiments, the cache system 688 may still incur some of the associated costs of checking for the timeout, e.g., by the cache manager 667.

TimeBoundedLocalCacheLayerConfigurator.cacheName.timeout

This configuration option may be used to set a timeout value for one or more data items in the time bounded cache layer. The timeout option may be set to any unit, such as in seconds, hours, days, or any combination thereof. In some embodiments, this configuration option takes a long value that sets the timeout in milliseconds for data items in the cache layer. In some embodiments, the timeout value can be positive or have a value of 0. In one embodiment, data items are removed or ejected after their TTL expires. Data items may be marked for removal or ejection from the cache layer when the data items' respective last access age (e.g., through “get”, “contains” or “put” operations) exceeds the timeout value. The timeout value can be altered at runtime and/or during a configuration stage. A change in the timeout value may affect all data items in the cache layer. In certain embodiments, there may be no significant costs associated with altering the timeout value. In one embodiment, the default timeout value is 1 hour (3,600,00 ms), although other values may be used. In certain embodiments, setting a small value for the timeout option can result in high cache throughput. This may have an impact on efficiency of the cache layer. In some embodiments, if the timeout value is higher than a corresponding TTL, the TTL may effectively disable the timeout setting. However, in some of these embodiments, the cache system 688 may still incur some of the associated costs of checking for the timeout, e.g., by the cache manager 667. Setting the timeout to 0 may be a preferred way for disabling the timeout.

TimeBoundedLocalCacheLayerConfigurator.cacheName.frequency

This configuration option may be used to set a frequency value of a cleanup thread used by the time bounded cache layer. The frequency option may be set to any unit, such as in seconds, hours, days, or any combination thereof. In some embodiments, this configuration option takes a long value that sets the frequency in milliseconds of the cleanup thread used by the cache layer. A cleanup thread may be any process, subroutine or program initiated by a cache manager or a cache layer to update or flush the cache layer. The cleanup thread may run periodically or at requested times. The cleanup thread may selectively or attempt to remove, delete, eject all data items in the cache layer. In some embodiments, the cleanup thread of the cache layer may attempt to remove data items marked for removal or ejection at regular intervals defined by the frequency option. In some embodiments, for example, due to the way the cache is implemented, the cleanup thread may not be able to remove all data items marked for removal or ejection. Data items that are missed, e.g., not successfully removed, may be handled by a checking process (e.g., lazy check) performed by the cache layer or system. For example, the checking process may attempt to remove the data items, or mark the data item for removal, e.g., via TTL or timeout. If the frequency is set to 0, the cleanup thread may not run. In this and some other cases, removal of expired items may be performed by the lazy checks. Data items may be removed when they are directly accessed, e.g., by a cleanup thread. In certain embodiments, operating a cache without a cleanup thread enabled may not be recommended. In some embodiments, the default frequency is set to 1 minute (60,000 ms), although other values may be used. In certain embodiments, setting a small value for frequency can result in a high load from checking the cache layer for expired values. This may impact the performance of the cache layer.

In some embodiments, a layered cache system 688 includes a time bounded cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a time bounded cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Memcached Cache Layer

In some embodiments, a layered cache system 688 includes a memcached cache layer. In one embodiment, this cache layer is a distributed caching layer that allows items to be stored in memcached. Memcached, in various embodiments, is an in-memory key-value store for data. Memcached may store small chunks of arbitrary data (strings, objects), for example from results of database calls, API calls, or page rendering. In some embodiments, the memcached layer cannot be configured. However, a memcached layer's underlying memcached instance(s) may be configured. A memcached instance may be shared and could be in use by one or more cache systems at various times. Therefore, it may be advisable to take care when altering values in a memcached instance. A memcached layer has a layer type of “memcached”. In some embodiments, a memcached layer uses the MemcachedConfigurator command for configuration purposes. In one of these embodiments, the command supports four configuration options:

MemcachedConfigurator.memcachedName.ttl

This configuration option may be used to set a TTL value to one or more data items in the memcached cache layer. The TTL value may be set to any unit, such as in seconds, hours, days, or any combination thereof. In some embodiments, this configuration option takes a numerical value, e.g., an integer value, that sets the TTL on data items stored in memcached. This value may be changed or update at runtime or during a configuration stage. In some embodiments, updating the value during runtime will only apply it to new objects being stored to the cache layer. Data items stored in the cache layer prior to a runtime update may maintain the TTL they were previously assigned with. In other embodiments, the value may be applied to some or all data items in the cache layer if a runtime update is performed, e.g., based on certain characteristic of data items stored or newly-added to the cache layer. In one embodiment, a default value for the TTL is 3 days (259,200 s), although other values may be used. In certain embodiments, setting a very small TTL value could result in high throughput in the cache layer. This may impact the efficiency of the cache layer.

MemcachedConfigurator.memcachedName.timeout

This configuration option may be used to set a timeout value for particular operations or calls in the cache layer. The timeout option may be set to any unit, such as in seconds, hours, days, or any combination thereof. In some embodiments, this configuration option takes a long value that determines the amount of time in milliseconds that a “get” or “contains” operation for example, will wait before timing out. If the “get” or ‘contains” operation times out, the cache manager 667 or cache layer may assume that the queried data item is not in the cache layer. This timeout value can be updated or changed at runtime or during a configuration stage. An updated timeout value for associated operations may apply to all future calls for these operations. In some embodiments, a default value for timeout is 200 ms, although other values may be used.

MemcachedConfigurator.memcachedName.delay

This configuration option may be used to set a delay value between runs of a monitor thread in the cache layer. In some embodiments, a monitor thread monitors and/or report the state and/or health of memcached servers and/or the cache layer. The delay value may be set to any unit, such as in seconds, hours, days, or any combination thereof. In some embodiments, this configuration option takes a long value that determines the delay, in milliseconds, between runs of a monitor thread. In certain embodiments, a monitor thread checks for changes in state in memcached servers providing or maintaining memcached functionality and infrastructure. The monitor thread may also check for updates to domain name service (DNS) entries used by the cache layer, cache system, memcached servers and/or the monitor thread. The delay value can be altered at runtime or during a configuration stage. In some embodiments, the default value for the delay option is 1 second (1000 ms), although other values may be used. Using a small value for delay may result in a higher load on the server. In certain embodiments, setting a large value may cause state changes to the memcached servers to be monitored and reported later. This may result in state changes being missed by the monitoring thread, e.g. if a memcached server goes offline and back online again in between monitoring checks).

MemcachedConfigurator.memcachedName.servers

This configuration option may be used to identify the memcached servers supporting the memcached cache layer. The option may take in a string of any combination of alphanumeric characters, special characters and delimiters. The option may take in a string of any character length. In some embodiments, this configuration option takes a string value listing the memcached servers to connect to in providing the memcached cache layer. In one embodiment, the format of the string is a comma-separated list of names in the format “server:port”. DNS aliases may be used in the string. These aliases may be expanded by the cache layer or cache manager when evaluated. The value of this configuration option may be altered at runtime or during a configuration stage. In one embodiment, the default value is “memcached:11211”, although other values may be used.

In certain embodiments, if a memcached layer is flushed, the memcached for the respective cache system is flushed. In other embodiments, the memcached for certain cache systems using the configured memcached servers are flushed. In yet other embodiments, if a memcached layer is flushed, the memcached for all cache systems using the configured memcached servers are flushed. To guard against this, the cache manager may not allow a default configuration for flushing a memcached cache. As an alternative, a JMX switch may be available in some embodiments, e.g., accessible under:

com.vibrantmedia.core.caching.configuration[type=LayeredCacheManagement]

Set MemcachedLocalCacheLayersFlushable to be true.

By accessing an associated info.jsp page, a link to flush the cache may be available. A user may have to manually confirm that he/she wishes to flush the cache layer before the memcached is flushed.

In some embodiments, a layered cache system 688 includes a memcached cache layer or instance as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a memcached cache layer or instance as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Logging Cache Layer

In some embodiments, a layered cache system 688 includes a logging cache layer. In one embodiment, a logging cache layer is a wrapper that instruments a layer by providing details on how often particular caching operations are performed, for example, the hit rate and the time taken to perform each operation. In some embodiments, the logging cache layer does not add a decorator to the full cache type indicator. However, if a decorator is added, applied or configured into the full cache type indicator, the cache system or platform may automatically display cache statistics on a cache information page 669. In one embodiments, a detail page of the cache information page 669 may provide a link to a graph page indicating cache characteristics. Some statistics of operations that may be logged, measured, tracked and/or monitored include:
puts—when a data item is put into a layer either via a parent layer or by a direct call, e.g., to a “put” operation. Internal updates to the cache may not be recorded as a “put” operation in some embodiments.
hits—when a call to a “get” operation, either via a parent layer or by a direct call, successfully returns. Internal calls to get may not be recorded as a hit in some embodiments.
misses—when a call to a “get” operation, either via a parent layer or by a direct call does not result in a hit. Internals calls to get may not be recorded as misses in some embodiments.
contains—when a check for a data item existing in the cache is made via a parent layer or by a direct call. Internal calls to contains may not be recorded in some embodiments.
deletes—when a call to a “delete” operation is made from either a parent layer or an external call. Internal cache clean-ups may not be recorded as “delete” operations in some embodiments.
flushes—when a call to a “flush” operation is made from either a parent layer or an external call.

In some embodiments, a logging cache layer is configured via the LoggingCacheLayerConfigurator command. In one embodiment, this command supports two options:

LoggingCacheLayerConfigurator.cacheName.range

This configuration option may be used to set a range value to determine a time period for monitoring by the logging layer. The range value may be specified in any unit, such as in seconds, hours, days, or any combination thereof. This configuration option may take in a numerical value, e.g., an integer value. The time period logged, monitored or measured by the logging layer is in some embodiments equal to the range multiplied by a configured interval value. In some embodiments, the range value cannot be altered at runtime. In other embodiments, the range value may be updated at runtime, e.g., and affects only newly-added data objects. The range value may be updated or changed during a configuration stage. In one embodiment, the range value defaults to 300, although other values may be used.

LoggingCacheLayerConfigurator.cacheName.interval

This configuration option may be used to set an interval value to determine a time period for monitoring by the logging layer. The interval value may be specified in any unit, such as in seconds, hours, days, or any combination thereof. This configuration option may take in a numerical value, e.g., an integer value. The time period logged, monitored or measured by the logging layer is in some embodiments equal to the range multiplied by a configured interval value. In some embodiments, statistics logged and/or reported by the logging layer is delayed by this interval. In some embodiments, the range value cannot be altered at runtime. In other embodiments, the range value may be updated at runtime, e.g., and affects only newly-added data objects. The range value may be updated or changed during a configuration stage. In one embodiment, the range value defaults to 1000, although other values may be used.

In some embodiments, a layered cache system 688 includes a logging cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a logging cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Synchronized Cache Layer

In some embodiments, a layered cache system 688 includes a synchronized cache layer. In certain embodiments, a synchronized cache layer is a specialist wrapper for encapsulating another cache layer. In one embodiment, a synchronized cache layer may be used as the top layer of a layered cache. The synchronized cache layer may allows for threadsafe access to a layered cache. Encapsulation of a cache layer with a synchronized cache layer may add a decorator [synchronized] to the encapsulated layer. In certain embodiments, there are no configuration options for the synchronized cache layer.

In some embodiments, a layered cache system 688 includes a synchronized cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a synchronized cache system 688 includes a default cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

### Keyfile Disk Cache Layer

In some embodiments, a layered cache system 688 includes a keyfile disk cache layer. In certain embodiments, a keyfile disk cache layer is a specialist wrapper for encapsulating another cache layer. In one embodiment, a keyfile disk cache layer may used to persist keyfiles to a disk. In certain embodiments, a keyfile disk cache layer cannot be flushed. In some embodiments, keyfiles, such as Vibrant Interest Advertisement (VIA) keyfiles, may be stored in a KeyfileCache.ArticlesRoot platform object. This platform object may defined by a platform property, e.g., in intellitxt.properties of the IntelliTXT platform. The value of the platform property may be read at start-up and may not be altered, e.g., during platform runtime. In some embodiments, there is no default for this value. In some of these embodiments, this value must be present in a properties file of the platform.

In certain embodiments, a keyfile disk supports selected calls to operations like get, put, contains, etc. For example and in one embodiment, a keyfile disk supports calls to such operations if the calls originated from VIA processing. Origination of the calls may be determined by checking a Via Key Cache of the platform. If a key passed into the keyfile disk cache layer in connection with a call is included in the Via Key Cache, the cache layer or cache manager may process this call. If the key does not exist in the Via Key Cache, cache layer or cache manager may process this call and return it as if the keyfile did not exist. In some embodiments, the cache layer or cache manager may not act on a call, e.g., in the case of a “put” operation, nothing will be performed. A logging cache layer may log some or all calls to an encapsulated keyfile disk cache layer. In some embodiments, due to particular implementations as to how a logging cache layer may process calls to the keyfile disk cache layer, all calls may be recorded or logged regardless of whether the calls originated from VIA processing.

As an example, a call to a “get” operation may be made on a keyfile disk cache layer. In connection with this, a key that passed in is found to not exist in the VIA Key Cache. The call may return as if no keyfile existed. If the layer is logged, a miss may be recorded by the associated logging layer. In another example and embodiment, a call to a “get” operation may be made on a keyfile disk cache layer. In connection with this, a key that passed in may be found to exist in the VIA Key Cache. A corresponding keyfile may exist on disk in the platform. The call may return the keyfile in this situation. If the layer is logged, a hit may be recorded by the associated logging layer.

In yet another example and embodiment, a call to a “get” operation is made on a keyfile disk cache layer. In connection with this, a key that passed in may be found to exist in the VIA Key Cache and keyfiles may not exist on disk. The call may return a null. If the layer is logged, a miss may be recorded by the associated logging layer.

In some embodiments, a layered cache system 688 includes a keyfile disk cache layer as an encapsulating layer (which may be a top layer or an intermediate layer) of a hierarchy of cache layers in combination with any one or more cache layers of the following cache layer types: synchronized, keyfile disk, memcached, default, size bounded, time bounded and logging cache layers. In other embodiments, a layered cache system 688 includes a keyfile disk cache layer as an encapsulated layer (which may be a bottom layer or an intermediate layer) of a hierarchy of cache layers in combination with any one or more cache layers of the following cache layer types: synchronized, keyfile disk, memcached, default, size bounded, time bounded and logging cache layers.

The platform may support a number of layered cache systems 688. By way of illustration and not intended to be limiting in any way, the following lists some types of layered cache systems 688:

Click Cache

A click cache may be used to identify or determine duplicate clicks. If a click (e.g., any user action such as a mouse-click, mouse-over, or other equivalents) is not fraudulent (e.g., performed by a malicious and/or automated program) and does not already exist in the click cache, the click may be added to the click cache. In one embodiment, this cache may include a size bounded layer wrapped in a time bounded layer. A memcached layer may be encapsulated below this. Both of the bounded layers may be logged (e.g., via encapsulation by a logging layer). The click cache may include a top encapsulating layer which is a synchronized cache layer. In one embodiment, the cache name for this cache, e.g., for configuration purposes, is clickCache.

View Cache

A view cache may be used to identify or determine duplicate ad views. If a view does not already exist in the view cache, it may be added to the view cache. In some embodiments, a view cache may include a size bounded layer wrapped in a time bounded layer. A memcached layer may be encapsulated below these layers. Both of the bounded layers may be logged. The view cache may include a top encapsulating layer which is a synchronized cache layer. In one embodiment, the cache name for this cache, e.g., for configuration purposes, is viewCache.

Via Key Cache

A via key cache may be an in-memory cache that stores keyfiles keys for VIA processing. For each call to a VIA, the via keyfile key may be generated and stored in this cache. The via key cache may not need to retain these keys for extended periods of time. The via key cache may be set with very low timeout and TTL values. The via key cache may be used in conjunction with the keyfile cache. In one embodiment, the cache name for this cache, e.g., for configuration purposes, is viaKeyCache.

Keyfile Cache

A keyfile cache may be used to store keyfiles. This cache may provide specialist features for VIA processing. For example, a keyfile disk layer of the keyfile cache may only store and retrieve keyfiles for a VIA call. In certain embodiments, keyfiles are stored in memory, then at a regional level, and then locally on disk for VIA purposes. A VIA call may be identified and determined by checking a keyfile key in a corresponding via key cache used in conjunction with the keyfile cache. In one embodiment, the cache name for this cache, e.g., for configuration purposes, is keyfileCache.

In some embodiments, each cache layer of a cache system 688 (e.g., click cache or view cache) can display a size value, e.g., to a reporting or information page. However, not all cache layers may be able to report on their size (for example the memcached layer). These latter cache layers may simply display a value of zero for the cache size regardless of the actual size of the cache.

In certain embodiments, logged layers can display statistics, e.g., total counts for occurrences: puts, hits, misses, contains, deletes and/or flushes. These occurrence types may correspond to calls via the platform and/or cache manager to perform an operation for put, get, contain, delete and flush, respectively. Hits and misses both relate to calls to perform an operation for “get”. A hit is where a non-null value is returned on a call to perform an operation for “get”. A miss may be recorded in any other event including when calls resulted in an error or a time-out. In certain embodiments, layers without logging may display ‘--’ in place of values for statistics.

In some embodiments, certain layers in a cache can be flushed independently. The cache manager may provide a confirmation dialog before a layer is flushed. Flushing regional caches may remove data for every web node in that region. Therefore, such operations on regional caches may warrant extra care. In some embodiments, some layers can refresh themselves from lower layers as part of a get operation. Thus, it may be advisable to flush a cache from the lowest layer up in these embodiments.

In certain embodiments, layered caching provides a highly flexible and configurable way of providing caching for various platforms and applications. Each layer in a cache is independently configurable, for example, via a cache manager and/or a database of a cache system. The cache manager and/or a database may be accessible via an interface, such as a programming or graphical user interface, for configuring a cache layer. Construction and layering of the cache system may be configured via a program or script code. Developers and systems administrators may use one or both of the programming or graphical user interface to perform the configuration. In some embodiments, a cache configuration is stored in the cache system 688. Depending on the cache and the parameter being configured, a cache configuration may be read either at cache system start up, or dynamically during normal operation. Details of a cache system, its layers and/or their configuration may be provided by an information page associated with the cache system 688.

Layered caching may provide better performance than a legacy system. Layered caching may provide a transparent replacement or alternative to legacy caching systems. In some embodiments, the switch 690 allows the caching strategy to be switched from the a legacy caching mechanism to layered caching and vice-versa. In one embodiment, such as on an IntelliTXT platform, one or more switches (e.g., JMX switches) for layered caching may be accessed via a management page (via port 8082 for a machine a user may wish to configure), residing under the object:

com.vibrantmedia.core.caching.configuration.

To access the switches, the user may click on: type=LayeredCacheManagement.

Some or all of the switches may have the format: Layered<CacheName>CacheEnabled, and may default to false, e.g., when the cache is first deployed. When defaulted to false, the legacy caching mechanism is in use. In some embodiments, changing this switch to true may disable the legacy caching infrastructure and enable layered caching.

A boolean database parameter layered<CacheName>CacheEnabled can be set in a parameter of the platform 600 (e.g., in INTELLITXTPARAMETERS) to override the default value. When caches are switched to a new mechanism, the previous cache structures are in some embodiments not destroyed and the data stored in the previous cache structures may not be flushed. In one embodiment, no new data are stored in the previous cache structures. Time bound caches may reduce in size over time as the time to live “TTL” limits are triggered for data items stored in the time bound caches.

In some embodiments, a layered caching system 688 may replace a legacy caching system. Code for a replaced legacy caching system or mechanism may be removed, e.g., from a hosting server 106 and/or switch 690. When there is no longer a need to switch between a replacement caching system and a legacy caching system, the respective switch 690 becomes redundant and may be removed. In some embodiments, one or more inactive cache systems 688 may be configured for the platform 600. In one embodiment, the one or more inactive cache systems 688 do not replace existing cache systems. Each of the one or more inactive cache systems 688 may be assigned to a shared switch or to a respective switch 690. Each assigned switch may be accessed via a management page as described above. Such a switch 690 may indicate that the corresponding non-replacement cache system is disabled or inactive. The switch 690 may further indicate that that no alternative cache is available in the non-replacement cache system's place.

The platform 600 may provide cache-related information to a user, developer or administrator. This information may include any form or type of information about the configuration, structure, status, contents, activity and/or statistics of cache systems provided by the platform 600. The platform 600 may provide this information via a graphical user interface and/or a reporting interface. In some embodiments, the platform 600 provides a cache information page 669. The cache information page 669 may be accessed via web browser in HTML and/or flash format, for example.

In some embodiments, the information page includes comprehensive details on cache systems 688 of the platform. The information page may include summaries and/or requested information on cache systems 688 of the platform. The information page may include a section listing one or more cache systems 688 in use or operation under the platform. The information page may list one or more layered cache systems that are active or deployed. The information page may list one or more cache layers of a cache system 688. In some embodiments, the information page provides any type or form of statistics (e.g., number of stored data items and the memory occupied) available for a particular cache system 688 and/or layer. These information (e.g., statistics and layer information) may be provided under an “existing cache” section. This section may grow in content as new cache systems are added or deployed. In some embodiments, the information page provides access to cached contents of each cache system or layer.

The information page may include a cache overview section or page. The cache overview section may report high level information on a cache system, such as cache name, layers, layer type and cache size. The cache overview section may format and present this information in any type or form. By way of illustration and not intended to be limiting in any way, the cache overview section may list the cache systems or caches by name. For example, each cache name may be displayed on a row by itself with a grey background. Below each cache name may be a row for each layer that belongs to the cache. Layers may be displayed in order so the first layer listed is the top layer in the cache. The cache overview section may display a layer type, cache size and flush link for each cache layer. For caches that are logged, the cache overview section may display statistics such as the number of times each type of cache operation was performed.

The information page may include a detail page or section. The information page may provide a link to a detail page. The detail page may display various aspects of the makeup, contents and configuration of a cache layer. Since a layer may include more than one component (e.g., decorators, etc), particular details on some or all of these components may be shown on the detail page. If configuration options exist for a particular cache layer, a ‘Data’ section may list each option and its current value. A description (e.g., full or concise description) of each component and associated configuration values are listed. A link, for example located near each layer name at the top of the page, may bring a user to a layer contents page. If a cache layer is logged, details on the logging component may be displayed. For example and in one embodiments, a table may show rolling averages and a peak duration for each operation. The detail page may also show rolling and total counts for each operation. The detail page may also provide a link will to a statistics page.

In some embodiments, a statistics page shows one or more graphs, plots, charts, tables and/or other presentation tools representing information recorded by a logging component. The statistics page may display the number of times each operation is called. The statistics page may display the number of hits and misses for each operation, e.g., over a rolling window. In some embodiments, the statistic page may show the average duration of each operation over this window. The statistics page may show peak and/or average values for logged data on graphs that span particular durations. Statistics pages may not exist for cache layers that are not logged.

The platform 600 may further provide a contents page. A contents page may show any type or form of information related to data items stored in a cache layer or cache system 688. In some embodiments, a contents page may display the contents of a cache layer. For layers that cannot display their contents (for example, the memcached layer), the content page may indicate so. The contents page may to display information related to the contents in each layer where applicable. For example and in one embodiment, timeout and TTL information on data items stored in a time bounded cache may be displayed in the contents page.

In some embodiments, a cache system configured via a database of the platform 600. The database may comprise a storage module of any type or form, such as any embodiment of memory modules 122, 128, 140 and/or databases 39 described above in connection with FIGS. 1B-C and 2. The database may serve as a central configuration point for one or more cache systems 688. The platform may provide any type or form of user interface or instructions interface for a user (e.g., an administrator or developer) to access the database and enter cache configuration. A cache manager 667 of each cache system 688 may access the database for the cache configuration. Cache configuration may include, for example, memory allocation, partitions, cache type, number of cache layers, layer type, maximum number of data items, TTL, timeout, etc.

In some embodiments, each layer of a cache system can be configured independently, e.g., via cache layer configuration parameters. A cache layer configuration parameter may sometimes be referred to as a cache layer configuration option. In one embodiment, a cache layer configuration parameter may take the form of: <ConfiguratorName>.<cacheName>.<parameterName>, examples of which are described above in connection with the cache layer types. <cacheName> may indicate a cache layer name. Some or all of the cache layer configuration parameters may be set on a platform parameter, e.g., INTELLITXTPARAMETERS. In some embodiments, a memcached layer is configured somewhat differently from cache layers of other types. By way of explanation, and in certain embodiments, a memcached layer may share a memcached instance with memcached layers of other cache systems. Rather than configuring a memcached layer directly, a user may configure the instance instead. In using a cache layer configuration parameter on a memcached layer, the corresponding memcached instance name may be used in place of the cache name or cache layer name. In certain embodiments, the memcached instance name (e.g., for configuration purposes) is regionalCache.

In certain embodiments, the name and type of each parameter depends on the cache layer. Whether a parameter is a dynamic or static parameter may also depend on the corresponding cache layer. A dynamic parameter may refer to a parameter that can be updated during runtime. A static parameter may refer to a parameter that cannot be updated during runtime. A static parameter may refer to a parameter that can only be updated during a configuration stage and/or during initial configuration or establishment of a corresponding cache system or layer.

A cache system or layer can be configured to accept updates when the cache system or layer is created or established. A cache system or layer that accepts updates may store values that a cache (e.g., an encapsulating cache layer) retrieves from a child cache (e.g., a cache layer encapsulated by the encapsulating cache layer). For example and in one embodiment, consider a layered cache with two cache layers, A and B. Layer A may be empty and layer B may contain an entry (i.e., data item) stored under the key K. A call to layer A for the data item stored under K may result in a call (e.g., “get” operation) to cache B for the item since the data item does not exist in layer A. If layer A is configured to accept updates, layer A may internally add the value for K into its own cache. Layer A may internally add the value for K into its own cache responsive to the call. Layer A may internally add the value for K into its own cache responsive to a determination that layer A does not contain the data item. Thus, after the call to the “get” operation, both layers may contain the data item. If layer A is not configured to accept updates, it may not update its own internal state. In this scenario, after the call to the “get” operation, the layers' respective cache contents may remain the same.

Referring now to FIG. 6B, a flow diagram depicts embodiments of steps taken in a method 620 for using a cache comprising a hierarchy of a plurality of cache layers of different types. The method includes establishing, by a cache manager executing on a device, a cache comprising a hierarchy of a plurality of cache layers (601). Each of the plurality of cache layers may be of a different type. A cache layer of the hierarchy may include a first cache type. Another cache layer of the hierarchy may include a second cache type. The method includes receiving, by the cache manager, a request for a data item (603). The method includes requesting, by the cache manager, the data item from the latter cache layer (605). The method includes determining that the data item does not exist in the latter cache layer (607). The method includes determining whether one of the click or the ad view is stored in one of the former cache layer or the latter cache layer (609). The method includes requesting the data item from the former cache layer responsive to the determination (611).

In further details of (601), a cache manager executing on a device establishes a cache comprising a hierarchy of a plurality of cache layers. A platform, embodiments of which are described above in connection with FIGS. 1A, 2, 5A, 5I and 6A, may create a configuration for a cache or cache system. The platform 600 may configure a server 106 to provide a cache 688. A user or program code may access a database of the platform to configure a cache. The platform 600 may, via the database, configure a server 106 or other device to provide or allocate memory space for the cache 688. The platform may, via the database, configure a server 106 or other device to configure, provide, establish and/or execute a cache manager 667 for the cache 688. The cache manager 667, upon executing on the server 106 or device, may use the cache configuration to establish the cache 688. The cache manager 667 may establish the cache as a layered or hierarchical cache having one or more cache layers, responsive to the cache configuration. In another embodiment, the cache manager 667 may establish the cache as any type or form of conventional, legacy, localized, distributed, virtual and/or hybrid cache system.

A user or program code may access a database of the platform 600 to configure a cache layer in the cache 688. The user or program code may use one or more configuration commands and/or configuration parameters to provide a configuration for a cache layer. The user or program code may create and/or store the cache layer configuration in the database. In some embodiments, some or all of the cache layer configuration is set or stored in a platform parameter, e.g., stored in the database. The platform 600 and/or database may transmit a cache layer configuration to a cache manager 667 executing on a server 106 or device.

The cache manager 667 may use the cache layer configuration to establish and/or manage one or more cache layers. The cache manager 667 may use the cache layer configuration to establish and/or manage a hierarchy of cache layers. The cache manager 667 may receive and/or use a cache layer configuration for each respective layer of the cache. Each of the plurality of cache layers may be of a different type 678. The cache manager 667 may establish a cache layer to be of a particular type 678 based on a cache layer configuration, a cache configuration and/or platform parameter. For example, the cache manager 667 may establish a first cache layer as a first cache type of a memory cache. In some embodiments, the cache manager 667 establishes a cache layer independently or separate from another cache layer. In other embodiments, the cache manager 667 establishes a cache layer in relation to another cache layer, e.g., having a hierarchical relationship.

A cache layer of the hierarchy may be of a particular (e.g., a first) cache type. Another (e.g., a second) cache layer of the hierarchy may include another (e.g., a second) cache type. The cache manager 667 may establish one cache layer to have a cache or layer type of one of a default cache layer, size bounded cache layer, a time bounded cache layer, a logging cache layer, a keyfile disk cache layer, a memcached cache layer or a synchronized cache layer, although not limited to these types. The cache manager 667 may establish another cache layer to have a same or different layer type from the other cache layers. The cache manager 667 may establish this other cache layer to have one of a default cache layer, size bounded cache layer, a time bounded cache layer, a logging cache layer, a keyfile disk cache layer, a memcached cache layer or a synchronized cache layer, although not limited to these types. The cache manager 667 may establish one or more other cache layers having a different or same layer type.

In relation to a particular (e.g., a first) cache layer, the cache manager 667 may establish another (e.g., second) cache layer to logically, structurally, functionally or other otherwise reside above or over the particular cache layer in a hierarchy of cache layers. In some embodiments, a cache layer is established to wrap around or encapsulate a another cache layer. In one embodiment, the top layer in a hierarchy of cache layers has a cache type of synchronized and/or logging. The cache manager 667 may establish multiple encapsulating cache layers in the cache. In some embodiments, the cache manager 667 may establish encapsulating cache layers of type synchronized, keyfile disk, time bounded, memcached or logging. In other embodiments, encapsulating cache layers may be of other types. In some embodiments, the cache manager 667 may establish encapsulated cache layers of type default, size bounded, keyfile disk, time bounded, memcached or logging. In other embodiments, encapsulated cache layers may be of other types.

The cache manager 667 may apply or transfer one or more properties, configuration, characteristics and/or functionalities of an encapsulating layer (i.e., a decorator) to an encapsulated layer. The cache manager 667 may apply or transfer one or more of these properties, configuration, characteristics and/or functionalities to an encapsulated layer via inheritance, association or otherwise. By way of illustration and in one embodiment, an encapsulating layer of type logging may provide logging or monitoring functionalities to operations on an encapsulated layer. As another example, the TTL of data items in an encapsulated layer may be modified by an encapsulating layer.

In some embodiments, the cache manager 667 establishes each cache layer of a plurality of cache layers on different networked computing devices (e.g., servers 106). The cache manager 667 may establish one or more cache layers of a plurality of cache layers to be distributed over one or more networked computing devices. The cache manager 667 may establish one or more cache layers as a distributed cache system, e.g., memcached. The cache manager 667 may establish a cache layer to be distributed over one or more regions or servers 106, for example, a memcached cache layer.

The cache manager 667 and/or cache 688 may receive a data item to cache. The cache manager 667 and/or cache 688 may receive this data item via a cache operation, e.g., put. The cache manager 667 and/or cache 688 may receive this data item from a switch 690 or another component of the platform 600. The cache manager 667 and/or cache 688 may receive this data item over one or more networks 104, 104′. The cache manager 667 may store the data item in each of the plurality of cache layers of the cache 688. In some embodiments, the cache manager 667 may store the data item to one or more particular layers, for example, based on the cache operation and/or cache layer configuration. In one embodiment, the cache manager 667 may store the data item to a specific cache layer, which may be encapsulating and/or encapsulated.

In certain embodiments, when a cache manager 667 stores a data item to an encapsulated layer, one or more encapsulating layers may also store the data item via copying, duplication, reformatting, linking, mapping and/or other operation. In some embodiments, when a cache manager 667 stores a data item to an encapsulating layer, one or more encapsulated layers may also store the data item via copying, duplication, reformatting, linking, mapping and/or other operation. The cache manager 667 and/or particular layers may remove, eject or delete a data item after storing the data item, for example, based on timeout, TTL, a flush operation, etc. For example, the cache manager 667 and/or a particular layer may flush the data item from that cache layer, e.g., based on a flush operation to that layer. One or more other cache layers may be unaffected by the timeout, TTL, flush operation, etc, and may maintain storage of the data item.

In further details of (603), the cache manager 667 receives, a request for a data item. The cache manager 667 may receive the request from a switch 690 or via another component of the platform 690. For example, the switch may direct the request to one or more caches and/or cache managers based on the content and nature of the request, the requestor, the status and/or load of a cache, etc. The request may be conveyed via any type or form of communication protocol, standard or proprietary. The request may be conveyed via a control channel, a signaling channel, or data transfer channel. The request may be conveyed via a secured connection, e.g., a SSL VPN connection to the cache 688. The cache 688 may receive the request and forward the request to its cache manager 667.

The platform 600 may generate the request for administrative purposes, e.g., collecting and compiling statistics for analysis, validating data, etc. The platform 600 may generate the request in response to an online user's action, e.g., a click on a hyperlink to retrieve an ad, an ad view. The platform 600 may generate the request to validate a click, ad view or other online action. The platform 600 may generate the request to check that a click, ad view or other online action is not fraudulent (e.g., generated by a program instead of a user). The platform 600 may generate the request to check that a click, ad view or other online action is not duplicated, e.g., already registered with, accounted for, or processed by the platform 600. The platform 600 may generate the request responsive to a user request for web content or other information. The platform 600 may generate the request as a scheduled and/or routine test for the operational status of the platform.

Referring now to (605), the cache manager requests the data item from a cache layer. The cache manager may request the data item from a cache layer (e.g., a second layer) encapsulating a particular layer (e.g., a first layer). The cache manager 667 may request the data item from the cache responsive to the received request. Based on the received request, the cache manager 667 may request the data item from one or more cache layers of the cache. For example, the cache layer may determine from the received request that it may be more efficient and/or more likely to retrieve the data item from a particular layer. The cache manager 667 may determine, based on the type of request and/or type of data item requested, to not request the data item from a particular layer. For example, the cache manager 667 may decide not to request the data item from a logging layer. The cache manager 667 may decide not to request a non-VIA data item from a keyfile Disk cache layer. In some embodiments, the cache manager 667 may request the data item from the top layer. In certain embodiments, the cache manager 667 may request the data item from the bottom layer.

In further details of (607), the cache manager and/or the cache layer determines that the data item does not exist in the cache layer requested to. The cache manager and/or the cache layer may process a cache operation corresponding to the request, e.g., a “get” or “contain” operation. The cache manager and/or the cache layer may perform any type of hashing into the cache layer to look for the requested data item. The cache manager and/or the cache layer may a log of the cache layer to determine if the requested data item is stored or deleted in the cache layer. The cache manager and/or the cache layer may use a name, identifier and/or attribute of the data item to search for the data item in the cache layer.

The cache manager and/or the cache layer may use any type of algorithm to perform a search for the data item in the cache layer. In one embodiment, the cache manager and/or the cache layer may sequentially search for the data item according to the particular arrangement of data items in the cache layer. In another embodiment, the cache manager and/or the cache layer may use a name, identifier and/or attribute of the data item to hash into the cache layer.

Referring now to (609), the cache manager and/or the cache layer requests the data item from another cache layer responsive to the determination. The cache manager and/or the cache layer requests the data item from another cache layer responsive to the determination that the data item is not in a first layer to which a request was directed. In some embodiments, the cache manager requests multiple cache layers for the data item, responsive to the received request. In other embodiments, a cache layer that receives a request for a data item may propagate the request to one or more other layers. For example, an encapsulated layer may propagate the request to one or more other upper, encapsulating layers.

An encapsulating layer may propagate the request to one or more other lower, encapsulated layers. The requests may be propagated sequentially, concurrently, or grouped according to particular layers. The requests may be propagated before a determination that the data item is not in a first layer to which a request was directed. The requests may be propagated to one or more other layers concurrent with, or independent of (607). The requests may be propagated responsive to a determination that the data item is not in a first layer to which a request was directed. For example and in one embodiments, a top layer that receives the request may propagate the request to an adjacent layer upon determining that the data item is not in the top layer. The adjacent layer may propagate the request to another layer upon determining that the data item is not in the adjacent layer. In some of these embodiments, the cache manager controls or coordinates the propagation of requests to one or more layers.

The cache manager 667 may respond to the request with the data item from one or more cache layers. The data item may be retrieved from a particular layer requested to, for example, a cache layer originally identified based on the request and/or by the cache manager 667. The data item may be retrieved from another layer because the requested layer does not have the data item in the requested layer's cache. The cache manager 667 may retrieve the data item and forward the data item to the switch 690 or platform 600.

In some embodiments, a layer receiving a request and which does not have the data item in its cache may copy or otherwise duplicate the data item from another layer for storage in its cache. This layer may request the data items from the other layer or from the cache manager 688. In certain embodiments, the cache manager 688 copies or updates the data item to one or more layers that do not have the data item.

Referring now to FIG. 6C, a flow diagram depicts embodiments of steps taken in a method 650 for determining duplicate clicks via a multi-layered cache. The method includes establishing, by a cache manager executing on a device, a cache comprising a hierarchy of a plurality of cache layers (651). The method includes establishing, by the cache manager, a (e.g., first) cache layer of the plurality of cache layers as a size bounded cache layer (653). The method includes establishing, by the cache manager, another (e.g., second) cache layer of the plurality of cache layers as a time bounded cache layer (655). The latter cache layer may encapsulate the former cache layer. The method includes receiving, by the cache manager, a request to determine whether one of a click or an ad view is stored in the cache (657). The method includes determining whether one of the click or the ad view is stored in one of the encapsulated (e.g., first) cache layer or the encapsulating (e.g., second) cache layer (659). The method includes flushing by the encapsulating cache layer a cached item from the latter cache layer responsive to expiration of a predetermined amount of time (661). The encapsulated cache layer may remove storage of the cached item The method includes flushing, by the encapsulated cache layer, a cached item from the encapsulated cache layer responsive to storage for the encapsulated cache layer exceeding a predetermined storage size (663). The encapsulating cache layer may maintain storage of the cached item.

Referring to (651), a cache manager executing on a device establishes a cache that includes a hierarchy of a plurality of cache layers. Various embodiments of steps corresponding to (651) are described above in connection with (601).

Referring to (653), the cache manager establishes a (e.g., first) cache layer of the plurality of cache layers as a size bounded cache layer. The cache manager may establish a size bounded cache layer using a cache layer configuration from a database of the platform 600. The cache manager may establish a size bounded cache layer using a cache layer configuration extracted from the platform parameter of the platform 600. The cache manager may establish a size bounded cache layer as a first cache layer. The cache manager may establish a size bounded cache layer for encapsulation by another layer. The cache manager may establish a size bounded cache layer to encapsulate another layer. The cache manager may establish a size bounded cache layer to apply size-bounds, other properties and/or functionalities on data items that will be stored in this cache layer. The cache manager may establish a size bounded cache layer to apply size-bounds, other properties and/or functionalities on data items that will be stored in one or more cache layers encapsulated by the size bounded cache layer.

In certain embodiments, the cache manager may establish a cache layer of a type other than a size bounded cache layer. In one embodiment, the cache manager may establish the first cache layer or the second cache layer as a synchronized cache layer. Various other embodiments of steps corresponding to (653) are described above in connection with (601).

Referring now to (655), the cache manager establishes another (e.g., second) cache layer of the plurality of cache layers as a time bounded cache layer. This cache layer may encapsulate another cache layer. The cache manager may establish a time bounded cache layer using a cache layer configuration from a database of the platform 600. The cache manager may establish a time bounded cache layer using a cache layer configuration extracted from the platform parameter of the platform 600. In certain embodiments, the cache manager may establish a time bounded cache layer as a first cache layer. The cache manager may establish a time bounded cache layer as a cache layer subsequent to the establishment of another layer. The cache manager may establish a time bounded cache layer for encapsulation by another layer.

The cache manager may establish a time bounded cache layer to encapsulate another layer. The cache manager may establish a time bounded cache layer to apply time-bounds, other properties and/or functionalities on data items that will be stored in this cache layer. The cache manager may establish a time bounded cache layer to apply time-bounds, other properties and/or functionalities on data items that will be stored in one or more cache layers encapsulated by the time bounded cache layer.

In certain embodiments, the cache manager may establish a cache layer of a type other than a time bounded cache layer. The cache manage may establish another (e.g., a third) cache layer of the memory cache encapsulated by a first (e.g., time bound) cache layer encapsulated by a second (e.g., size bound) cache layer. This cache layer encapsulated by the other layers may inherit or acquire one or more properties, features and/or functionalities of the encapsulating layers. Any number of encapsulating layers may apply. In some embodiments, the cache manager 667 may establish one of the encapsulating cache layers as a logging cache layer. One or more layers encapsulated by the logging cache layer may inherit or acquire one or more properties, features and/or functionalities of the logging cache layer. For example, calls to operations on a layer encapsulated by the logging cache layer may be monitored or logged according to the properties of the logging layer. Various other embodiments of steps corresponding to (653) are described above in connection with (601).

Referring to (657), the cache manager receives a request to determine whether one of a click or an ad view is stored in the cache. Any information about a click or an ad view may be included in a data item for storage in the cache. For example, any information about a user, webpage, date, time, related content, ad, etc, related to a click may be stored as a data item. The platform 600 may want to determine whether a click or ad view has already been counted, registered or accounted for. The platform may store a data item corresponding to each user action, e.g., a click on a hyperlink linked to an ad, or an ad view. A first user action and any additional (e.g., duplicate) user actions may be counted as a single completed action. To avoid counting and/or storing duplicate actions, the platform may check its cache system(s) for records of prior completed actions.

The switch 690 that conveys the request to the cache manager 667 may determine the type of the request (e.g., whether it is a click or ad view request). Based on the determination, the switch 690 may forward or transmit the request to an appropriate cache 668 and/or cache manager 667. For example, if the request is a click request, the switch 690 may forward the request to one or more click caches. In some embodiments cache manager may check that the type of the request received is supported by its cache 688. If the request type does not match the cache type, the cache manager 667 may inform the platform or ignore the request. In some embodiments, the cache manager 667 may forward the request to another cache 668b.

Based on the request, the cache manager may request one or more cache layers for an appropriate data item, e.g., a click or ad view data item or record. Various other embodiments of steps corresponding to (657) are described above in connection with (603).

In further details of (659), the cache manager determines whether the click or the ad view is stored in the time bounded (e.g., encapsulated or first) cache layer or the size bounded (e.g., encapsulating or second) cache layer. The time bounded cache layer may determine whether the click or the ad view is stored in the time bounded cache layer. The size bounded cache layer may determine whether the click or the ad view is stored in the size bounded cache layer. The cache manager may determine whether the click or the ad view is stored in another cache layer.

In one embodiment, a size bounded cache layer may determine that the click or the ad view is not stored in the size bounded cache layer. The size bounded cache layer may communicate the same or another (e.g., second) request to another layer. For example, the request may be communicated to a time bounded layer, or a layer adjacent to the size bounded cache layer in a hierarchy of cache layers. In another embodiment, a time bounded cache layer may determine that the click or the ad view is not stored in the time bounded cache layer. The time bounded cache layer may communicate the same or another request to another layer. For example, the request may be communicated to a size bounded layer, or a layer adjacent to the size bounded cache layer in a hierarchy of cache layers. In various embodiments, a cache layer may determine that a click or the ad view is not stored in that cache layer, and may communicate the request to another layer. The request may be communicated to another layer to determine if the identified click, ad view or data items is stored in another layer. In some embodiments, the request is generated and/or communicated to another layer by the cache manager 667. Various other embodiments of steps corresponding to (659) are described above in connection with (607) and (609).

The cache manager may respond to the request (to determine whether a click or an ad view is stored in the cache) with information about the click or the ad view as stored in one or the cache layers. The cache manager may include a corresponding data item stored in one or the cache layers in a response to the request. The cache manager may generate a response based on the information stored in the data item. For example, the cache manager 667 may respond that the click or ad view is duplicated based on the information stored in the data item. The cache manager 667 may respond that the click or ad view is not duplicated based on the information stored in the data item. The cache manager 667 may respond that the click or ad view is not duplicated if there is no corresponding data item in any cache layer. Certain other embodiments of steps corresponding to the cache manager's response are described above in connection with (609).

In further details of (661), the cache manager and/or the time bounded cache layer flushes or removes a cached item from the time bounded cache layer responsive to expiration of a predetermined amount of time. The cache manager and/or the time bounded cache layer may remove, delete or eject a cached data item from the time bounded cache layer responsive to a TTL, timeout or a flush operation. In certain embodiments, a size bounded cache layer may maintain storage of the same data item. In some embodiments, the size bounded cache layer may maintain storage of the same data item in its cache if it encapsulates the time bounded cache layer. A size bounded cache layer may maintain storage of the same data item in its cache if it is above the time bounded cache layer in the hierarchy of cache layers.

In some embodiments, the size bounded cache layer may remove the same data item in its cache if it is encapsulated by the time bounded cache layer. A size bounded cache layer may remove the same data item in its cache if it is below the time bounded cache layer in the hierarchy of cache layers. This cache layer may remove the data item because this cache layer adopts a property (e.g., TTL, timeout) from a higher and/or encapsulating time bounded cache layer. One or more layers of any type, in the cache 688 other than the time bounded cache layer, may be similarly affected. In various embodiments, (661) may occur at any time and does not have to occur after (659).

In further details of (663), the size bounded (e.g., encapsulated or first) cache layer flushes or removes a cached item from the size bounded cache layer responsive to storage for the size bounded cache layer exceeding a predetermined storage size. The cache manager and/or the size bounded cache layer may remove, delete or eject a cached item from the time bounded cache layer responsive to exceeding a maximum size limit (e.g., based on the number of data items). In some embodiments, the time bounded cache layer may maintain storage of the cached item. The time bounded cache layer may maintain storage of the cached item if it encapsulates the size bounded cache layer. The time bounded cache layer may maintain storage of the cached item if it higher in the hierarchy of cache layers than the size bounded cache layer.

The time bounded cache layer may remove the cached item if it is encapsulated by the size bounded cache layer. The time bounded cache layer may remove the cached item if it lower in the hierarchy of cache layers than the size bounded cache layer. The time bounded cache layer may remove the data item because this cache layer adopts a property (e.g., maximum size) from a higher and/or encapsulating size bounded cache layer. One or more layers of any type, in the cache 688 other than the size bounded cache layer, may be similarly affected. In various embodiments, (663) may occur at any time and does not have to occur after (659).

Specific cache types and layer types may be described above for illustration purposes and are not intended to be limiting in any way. It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the invention has been particularly shown and described with reference to specific embodiments, it should be understood by those skilled in the art that various changes in form and detail may be made therein without departing from the spirit and scope of the invention described in this disclosure.

What is claimed:

1. A method of using a cache comprising a hierarchy of a plurality of cache layers of different types, the method comprising:
(a) establishing, by a cache manager executing on a device, a cache comprising a hierarchy of a plurality of cache layers, each of the plurality of cache layers of a different type, a first cache layer of the hierarchy comprising a first cache type and a second cache layer of the hierarchy comprising a second cache type.
(b) receiving, by the cache manager, a request for a data item;
(c) requesting, by the cache manager, the data item from the second cache layer;
(d) determining that the data item does not exist in the second cache layer; and
(e) requesting the data item from the first cache layer responsive to the determination.

2. The method of claim 1, wherein step (a) further comprises establishing a second cache layer as a second cache type of one of a size bounded cache layer, a time bounded cache layer, a logging cache layer or a synchronized cache layer.

3. The method of claim 1, wherein step (a) further comprises establishing a first cache layer as a first cache type of a memory cache.

4. The method of claim 1, wherein step (a) further comprising receiving by the cache manager, a data item to cache, the data item stored in each of the plurality of cache layers.

5. The method of claim 1, further comprising storing the data item to the second cache layer.

6. The method of claim 1, wherein step (a) further comprises establishing the second cache layer as encapsulating the first cache layer.

7. The method of claim 1, wherein step (e) further comprises requesting by one of the cache manager or the second cache layer, the data item from the first cache layer.

8. The method of claim 1, further comprising responding, by the cache manager, to the request with the data item from the first cache layer.

9. The method of claim 1, further comprising flushing, by one of the cache manager or the second cache layer, the data item from the second cache layer, the first cache layer maintaining storage of the data item.

10. The method of claim 1, wherein step (a) further comprises establishing each cache layer of the plurality of cache layers on different networked computing devices.

11. A method for determining duplicate clicks via a multi-layered cache, the method comprising:
(a) establishing, by a cache manager executing on a device, a cache comprising a hierarchy of a plurality of cache layers;
(b) establishing, by the cache manager a first cache layer of the plurality of cache layers as a size bounded cache layer;
(c) establishing, by the cache manager, a second cache layer of the plurality of cache layers as a time bounded cache layer, the second cache layer encapsulating the first cache layer;
(d) receiving, by the cache manager, a request to determine whether one of a click or an ad view is stored in the cache; and
(e) determining whether one of the click or the ad view is stored in one of the first cache layer or the second cache layer.

12. The method of claim 1, wherein step (e) further comprises determining by the second cache layer that one of the click or the ad view is not stored in the second cache layer and communicating a second request to the first cache layer to determine if one of the click or the ad view is stored in the first cache layer.

13. The method of claim 12, further comprising responding by the cache manager to the request with information about one of the click or the ad view as stored in the first cache layer.

14. The method of claim 1, wherein step (e) further comprises determining by the cache manager that the click is not stored in the second cache layer and communicating a second request to the first cache layer to determine if the click is stored in the first cache layer.

15. The method of claim 1, wherein step (c) further comprises establishing a third cache layer of a memory cache encapsulated by the first cache layer encapsulated by the second cache layer.

16. The method of claim 1, further comprising establishing one of the first cache layer or the second cache layer as a logging cache layer.

17. The method of claim 1, further comprising establishing one of the first cache layer or the second cache layer as a synchronized cache layer.

18. The method of claim 1, further comprising flushing by the second cache layer a cached item from the second cache layer responsive to expiration of a predetermined amount of time, the first cache layer flushing storage of the cached item.

19. The method of claim 1, further comprising flushing by the first cache layer a cached item from the first cache layer responsive to storage for the first cache layer exceeding a predetermined storage size, the second cache layer maintaining storage of the cached item.

20. The method of claim 1, further comprising establishing the first cache layer on a first device and the second cache layer on a second device.
